(19) United States
(12) Patent Application Publication
(10) Pub. No.: US 2026/0136161 A1
(43) Pub. Date: May 14, 2026

(54) DATA COLLECTION AND PROCESSING METHOD AND APPARATUS, COMMUNICATION DEVICE, AND READABLE STORAGE MEDIUM

(71) Applicant: VIVO MOBILE COMMUNICATION CO., LTD., Dongguan (CN)

(72) Inventors: Tong ZHOU, Dongguan (CN); Hao WU, Dongguan (CN)

(21) Appl. No.: 19/445,673

(22) Filed: Jan. 12, 2026

Related U.S. Application Data
(63) Continuation of application No. PCT/CN2024/103417, filed on Jul. 3, 2024.

(30) Foreign Application Priority Data
Jul. 10, 2023 (CN) 202310845843.0

(51) Int. Cl. H04W 4/38; H04L 41/16; H04W 24/08

(52) U.S. Cl. CPC H04W 4/38; H04L 41/16; H04W 24/08

(57) ABSTRACT

A data collection and processing method and a communication device are disclosed. The method includes: A first device receives first information sent by a second device, where the first information includes target identifiers and pieces of target information indicating N items of mapping data, which correspond to N parameters of sensitive information of the second device, the pieces of target information are obtained by performing data mapping on the N parameters according to target data mapping manners, and the target identifiers indicate the target data mapping manners. The first device generates a data set according to the pieces of target information. The first device performs, according to the target identifiers and the data set, at least one of: training an AI unit, at least one of the AI unit and the data set being associated with the target identifiers; performing inference on the AI unit; monitoring the AI unit.

### CROSS-REFERENCE TO RELATED APPLICATIONS

This application is a continuation of International Patent Application No. PCT/CN2024/103417, filed on Jul. 3, 2024, which claims priority to Chinese Patent Application No. 202310845843.0, filed with the China National Intellectual Property Administration on Jul. 10, 2023, and entitled “DATA COLLECTION AND PROCESSING METHOD AND APPARATUS, COMMUNICATION DEVICE, AND READABLE STORAGE MEDIUM”, which are incorporated herein by reference in their entirety.

### TECHNICAL FIELD

This application relates to the field of communication technologies, and in particular, to a data collection and processing method and apparatus, a communication device, and a readable storage medium.

### BACKGROUND

In millimeter wave wireless communication, a plurality of analog beams are configured on communication transceiver ends (for example, a base station and a terminal device). For a same terminal device, channel quality obtained by measurement on different transmitted and received analog beam varies. How to quickly and accurately find a transceiver beam group having the highest channel quality from all possible transceiver analog beam combinations is a key to affecting transmission quality. After an artificial intelligence (Artificial Intelligence, AI) neural network model is introduced, the terminal device may effectively predict, according to historical channel quality information, a transceiver analog beam pair having the highest channel quality, and report the transceiver analog beam pair to a network side.

During beam pair prediction, if detailed beam information can be provided, prediction accuracy can be improved. However, beam information such as a beam direction, a shape of the beam, and a width of the beam at 3 dB all belong to relatively sensitive information. Directly exposing the beam information to a peer end has a risk of exposing the sensitive information.

### SUMMARY

Embodiments of this application provide a data collection and processing method and apparatus, a communication device, and a readable storage medium.

According to a first aspect, a data collection method is provided, including:

A first device receives first information sent by a second device, where the first information includes target identifiers and a plurality of pieces of target information, the plurality of pieces of target information are used to indicate N items of mapping data, which correspond to N parameters of sensitive information of the second device, the plurality of pieces of target information are obtained by performing data mapping on the N parameters according to target data mapping manners, and the target identifiers are used to indicate the target data mapping manners, where N is an integer greater than 1.

The first device generates a data set according to the plurality of pieces of target information.

The first device performs, according to the target identifiers and the data set, at least one of the following:
training an artificial intelligence AI unit, where at least one of the AI unit and the data set is associated with the target identifiers;
performing inference on the AI unit; or
monitoring the AI unit.

According to a second aspect, a data collection method is provided, including:

A second device performs data mapping on N parameters of its plurality of pieces of sensitive information according to target data mapping manners, to obtain a plurality of pieces of target information, where the plurality of pieces of target information are used to indicate N items of mapping data corresponding to the N parameters, where N is an integer greater than 1.

The second device sends first information to a first device, where the first information includes the plurality of pieces of target information and target identifiers, the target identifiers are used to indicate the target data mapping manners, and the N items of mapping data are used to generate a data set.

The data set is used to perform at least one of the following:
training an artificial intelligence AI unit, where at least one of the AI unit and the data set is associated with the target identifiers;
performing inference on the AI unit; or
monitoring the AI unit.

According to a third aspect, a data collection apparatus is provided, applied to a first device, and including:
a first receiving module, configured to receive first information sent by a second device, where the first information includes target identifiers and a plurality of pieces of target information, the plurality of pieces of target information are used to indicate N items of mapping data, which correspond to N parameters of sensitive information of the second device, the plurality of pieces of target information are obtained by performing data mapping on the N parameters according to target data mapping manners, and the target identifiers are used to indicate the target data mapping manners, where N is an integer greater than 1;
a generating module, configured to generate a data set according to the plurality of pieces of target information; and
an execution module, configured to perform, according to the target identifiers and the data set, at least one of the following:
training an artificial intelligence AI unit, where at least one of the AI unit and the data set is associated with the target identifiers;
performing inference on the AI unit; or
monitoring the AI unit.

According to a fourth aspect, a data collection apparatus is provided, applied to a second device, and including:
a mapping module, configured to perform data mapping on N parameters of its plurality of pieces of sensitive information according to target data mapping manners, to obtain a plurality of pieces of target information, where the plurality of pieces of target information are used to indicate N items of mapping data corresponding to the N parameters, where N is an integer greater than 1; and
a first sending module, configured to send first information to a first device, where the first information includes the plurality of pieces of target information and target identifiers, the target identifiers are used to indicate the target data mapping manners, and the N items of mapping data are used to generate a data set.

The data set is used to perform at least one of the following:
training an artificial intelligence AI unit, where at least one of the AI unit and the data set is associated with the target identifiers;
performing inference on the AI unit; or
monitoring the AI unit.

According to a fifth aspect, a communication device is provided. The terminal includes a processor and a memory. The memory stores a program or an instruction executable in the processor. The program or the instruction, when executed by the processor, implements the steps of the method in the first aspect or the second aspect.

According to a sixth aspect, a communication device is provided, including a processor and a communication interface.

When the communication device is used as a first device, the communication interface is configured to receive first information sent by a second device, where the first information includes target identifiers and a plurality of pieces of target information, the plurality of pieces of target information are used to indicate N items of mapping data, which correspond to N parameters of sensitive information of the second device, the plurality of pieces of target information are obtained by performing data mapping on the N parameters according to target data mapping manners, and the target identifiers are used to indicate the target data mapping manners, where N is an integer greater than 1.

The processor is configured to generate a data set according to the plurality of pieces of target information.

According to the target identifiers and the data set, at least one of the following is performed:
training an artificial intelligence AI unit, where at least one of the AI unit and the data set is associated with the target identifiers;
performing inference on the AI unit; or
monitoring the AI unit.

When the communication device is used as a second device, the processor is configured to perform data mapping on N parameters of sensitive information of the second device according to target data mapping manners, to obtain a plurality of pieces of target information, where the plurality of pieces of target information are used to indicate N items of mapping data corresponding to the N parameters.

The communication interface is configured to send first information to a first device, where the first information includes the plurality of pieces of target information and target identifiers, the target identifiers are used to indicate the target data mapping manners, and the N items of mapping data are used to generate a data set.

The data set is used to perform at least one of the following:
training an artificial intelligence AI unit, where at least one of the AI unit and the data set is associated with the target identifiers;
performing inference on the AI unit; or
monitoring the AI unit.

According to a seventh aspect, a communication system is provided, including a first device and a second device. The first device may be configured to perform the steps of the method in the first aspect. The second device may be configured to perform the steps of the method in the second aspect.

According to an eighth aspect, a readable storage medium is provided. The readable storage medium stores a program or an instruction. The program or the instruction, when executed by a processor, implements the steps of the method in the first aspect, or implements the steps of the method in the second aspect.

According to a ninth aspect, a chip is provided. The chip includes a processor and a communication interface. The communication interface is coupled to the processor. The processor is configured to run a program or an instruction to implement the method in the first aspect, or to implement the method in the second aspect.

According to a twelfth aspect, a computer program/program product is provided. The computer program/program product is stored in a storage medium. The program/program product is executed by at least one processor to implement the method in the first aspect, or to implement the method in the second aspect.

In this embodiment of this application, the first device can receive the first information sent by the second device, which includes the target identifiers and the plurality of pieces of target information, and generate the data set according to the plurality of pieces of target information. Herein, the data set is used for performing at least one of “training an AI unit, performing inference on the AI unit, and monitoring the AI unit”, and at least one of the AI unit and the data set is associated with the target identifiers. The plurality of pieces of target information are used to indicate N items of mapping data corresponding to the N parameters of the sensitive information of the second device, the plurality of pieces of target information are obtained by performing data mapping on the N parameters according to the target data mapping manners, and the target identifiers are used to indicate the target data mapping manners.

### BRIEF DESCRIPTION OF THE DRAWINGS

FIG. 1 is a block diagram of a wireless communication system to which an embodiment of this application may be applied;

FIG. 2 is a schematic flowchart of a data collection method according to an embodiment of this application;

FIG. 3 is a schematic flowchart of another data collection method according to an embodiment of this application;

FIG. 4 is a schematic flowchart of an implementation 1-1 of a data collection method according to an embodiment of this application;

FIG. 5 is a schematic flowchart of an implementation 1-2 of a data collection method according to an embodiment of this application;

FIG. 6 is a schematic flowchart of an implementation 1-3 of a data collection method according to an embodiment of this application;

FIG. 7 is a schematic flowchart of an implementation 2-1 of a data collection method according to an embodiment of this application;

FIG. 8 is a schematic flowchart of an implementation 2-2 of a data collection method according to an embodiment of this application;

FIG. 9 is a schematic flowchart of an implementation 2-3 of a data collection method according to an embodiment of this application;

FIG. 10 is a schematic flowchart of an implementation 3-1 of a data collection method according to an embodiment of this application;

FIG. 11 is a schematic flowchart of an implementation 3-2 of a data collection method according to an embodiment of this application;

FIG. 12 is a schematic flowchart of an implementation 3-3 of a data collection method according to an embodiment of this application;

FIG. 13 is a schematic flowchart of an implementation 4-1 of a data collection method according to an embodiment of this application;

FIG. 14 is a schematic flowchart of an implementation 4-2 of a data collection method according to an embodiment of this application;

FIG. 15 is a schematic flowchart of an implementation 4-3 of a data collection method according to an embodiment of this application;

FIG. 16 is a structural block diagram of a data collection apparatus according to an embodiment of this application;

FIG. 17 is a structural block diagram of another data collection apparatus according to an embodiment of this application;

FIG. 18 is a structural block diagram of a communication device according to an embodiment of this application;

FIG. 19 is a structural block diagram of a terminal according to an embodiment of this application; and

FIG. 20 is a structural block diagram of a network side device according to an embodiment of this application.

### DETAILED DESCRIPTION

Technical solutions in embodiments of this application are clearly described below with reference to the accompanying drawings in embodiments of this application. Apparently, the described embodiments are merely some rather than all embodiments of this application. All other embodiments obtained by a person of ordinary skill in the art according to embodiments of this application fall within the protection scope of this application.

Terms “first”, “second”, and the like in this application are used to distinguish between similar objects rather than describe a specific order or sequence. It should be understood that the terms used in this case may be transposed where appropriate, so that embodiments of this application may be implemented in a sequence other than those illustrated or described herein. In addition, objects defined by “first” and “second” are generally of the same class and do not limit a quantity of objects. For example, one first object may be arranged, or a plurality of objects may be arranged. In addition, “or” in this application indicates at least one of connected objects. For example, “A or B” encompasses three solutions: solution I: A is included but B is not included; solution II: B is included but A is not included; and solution III: both A and B are included. A character “/” generally indicates an “or” relationship between associated objects.

A term “indication” in this application may be a direct indication (or an explicit indication) or an indirect indication (or an implicit indication). The direct instruction may be understood as that a sending party clearly informs a receiving party of specific information, an operation to be performed, or a request result in the sent instruction. The indirect indication may be understood as that the receiving party determines corresponding information according to an indication sent by the sending party, or makes a determination and determines, according to a determining result, an operation that needs to be performed or a request result.

It should be noted that, technologies described in embodiments of this application may be applied to a long term evolution (Long Term Evolution, LTE)/LTE-advanced (LTE-Advanced, LTE-A) system, and may be further applied to another wireless communication system, such as a code division multiple access (Code Division Multiple Access, CDMA) system, a time division multiple access (Time Division Multiple Access, TDMA) system, a frequency division multiple access (Frequency Division Multiple Access, FDMA) system, an orthogonal frequency division multiple access (Orthogonal Frequency Division Multiple Access, OFDMA) system, a single-carrier frequency division multiple access (Single-carrier Frequency Division Multiple Access, SC-FDMA) system, or another system. Terms “system” and “network” in embodiments of this application are usually interchangeably used, and the described technology may be used for both the system and the radio technology mentioned above, or may be used for another system and another radio technology. A new radio (New Radio, NR) system is described below as an example, and the term NR is used in most of the following description. Nevertheless, the technologies may also be applied to a system other than the NR system, such as a 6^{th} generation (6^{th} Generation, 6G) communication system.

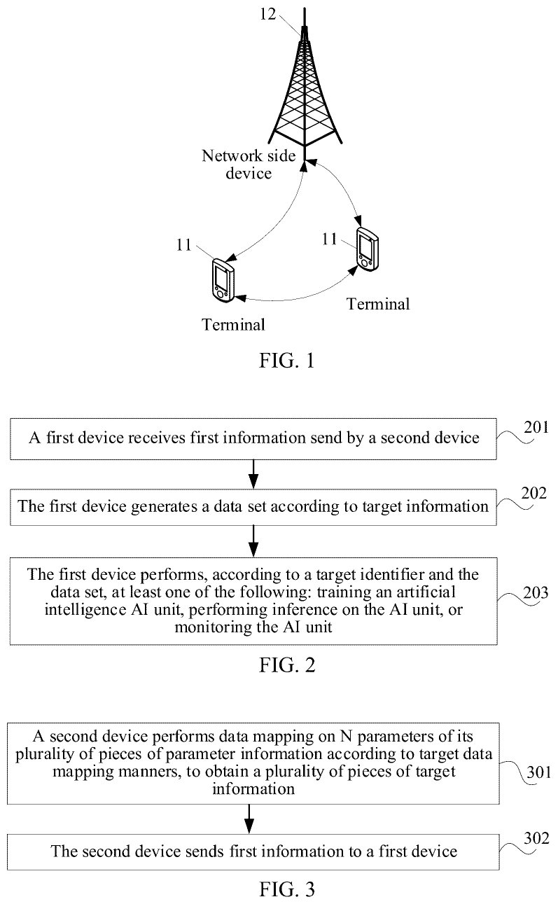

FIG. 1 is a block diagram showing a wireless communication system to which an embodiment of this application may be applied. The wireless communication system includes a terminal 11 and a network side device 12. The terminal 11 may be a terminal side device such as a mobile phone, a tablet computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR), a virtual reality (Virtual Reality, VR) device, a robot, a wearable device (Wearable Device), a flight vehicle (flight vehicle), an on-board device (Vehicle User Equipment, VUE), a shipborne device, a pedestrian terminal (Pedestrian User Equipment, PUE), a smart home appliance (a home device with a wireless communication capability, such as a refrigerator, a television, a washing machine, or furniture), a game console, a personal computer (Personal Computer, PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart bangle, a smart ankle chain, and the like), a smart wristband, smart clothing, and the like. The on-board device may also be referred to as an on-board terminal, an on-board controller, an on-board module, an on-board component, an on-board chip, an on-board unit, or the like. It should be noted that a specific type of the terminal 11 is not limited in embodiments of this application.

The network side device 12 may include an access network device or a core network device. The access network device may also be referred to as a radio access network (Radio Access Network, RAN) device, a wireless access network function, or a wireless access network unit. The access network device may include a base station, a wireless local area network (Wireless Local Area Network, WLAN) access point (Access Point, AS), a wireless fidelity (Wireless Fidelity, Wi-Fi) node, or the like. The base station may be referred to as a node B (Node B, NB), an evolved Node B (Evolved Node B, eNB), a next generation Node B (the next generation Node B, gNB), a new radio Node B (New Radio Node B, NR Node B), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home node B (home Node B, HNB), a home evolved node B (home evolved Node B), a transmission receiving point (Transmission Reception Point, TRP), or another appropriate term in the art. The base station is not limited to a specific technical term, as long as the same technical effect can be achieved. It should be noted that, in this embodiment of this application, only a base station in an NR system is used as an example for description, and a specific type of the base station is not limited.

It may be learned that in the related art, in a process of using an AI unit, when the sensitive information such as beam information is directly transmitted between devices, a risk that the sensitive information is easily exposed exists.

Embodiments of this application provide a data collection and processing method and apparatus, a communication device, and a readable storage medium, to resolve a problem in the prior art that in a process of using an AI unit, sensitive information such as beam information is directly transmitted between devices, thereby exposing the sensitive information.

A data collection method provided in embodiments of this application is described below in detail through some embodiments and application scenarios thereof with reference to the accompanying drawings.

According to a first aspect, as shown in FIG. 2, an embodiment of this application provides a data collection method. The method is performed by a first device, the first device may be a terminal, and the method includes the following steps.

Step 201: A first device receives first information send by a second device.

The first information includes target identifiers and a plurality of pieces of target information. The plurality of pieces of target information are used to indicate N items of mapping data, which correspond to N parameters of sensitive information of the second device, or the plurality of pieces of target information are used to represent the N items of mapping data corresponding to the N parameters. The plurality of pieces of target information are obtained by performing data mapping on the N parameters according to target data mapping manners, and the target identifiers are used to indicate the target data mapping manners, where N is an integer greater than 1.

In addition, the target identifier may be represented by a data set identifier, a data acquisition identifier, a data collection identifier, a data processing identifier, a data privacy processing identifier, or the like.

It may be learned that the second device performs data mapping on the N parameters of the plurality of pieces of sensitive information of the second device according to the target data mapping manners to obtain the plurality of pieces of target information used for indicating (or representing) the N items of mapping data corresponding to the N parameters, thereby sending the plurality of pieces of target information and the target identifiers used for indicating the target data mapping manner to the first device.

It can be seen that the N parameters of the sensitive information of the second device are mapped according to the target data mapping manners, to obtain the plurality of pieces of target information used for indicating (or representing) the N items of mapping data corresponding to the N parameters. In this way, what the second device sends to the first device is no longer actual N parameters, but the mapped target information. Therefore, even if a peer end receives the plurality of pieces of target information, the actual N parameters cannot be obtained according to the plurality of pieces of target information. Therefore, the plurality of pieces of target information is used as privacy information of the N parameters of the second device herein, and the target data mapping manners may also be referred to as data privacy methods (methods for removing sensitive information).

Optionally, the plurality of pieces of sensitive information includes transmit beam directions, and the N parameters include N direction dimensions of the transmit beam directions. The N dimensions may include a horizontal direction and a vertical direction.

The second device may perform, according to the target data mapping manners, data mapping on the N direction dimensions (for example, the horizontal direction and the vertical direction) of the transmit beam directions of the second device, to obtain the plurality data of the N direction dimensions. In this way, what is transmitted between the first device and the second device is no longer the actual beam directions, but the mapping data (or referred to as privacy data) of the beam directions, thereby avoiding exposure of the actual beam directions and improving data security.

It should be noted that when data mapping is performed on the N direction dimensions according to the target data mapping manners, data mapping may be performed on angles of the N direction dimensions, or data mapping may be performed on physical identifiers of the N direction dimensions. For example, the vertical direction includes a direction from four angles: 22.5, 67.5, 112.5, and 157.5, and physical identifiers corresponding to the four angles are respectively x1, x2, x3, and x4. In this case, data mapping may be performed on the four angles “22.5, 67.5, 112.5, and 157.5” according to the target data mapping manners, or data mapping may be performed on the four physical identifiers “x1, x2, x3, and x4”.

It may be understood that the sensitive information may further include another information other than the transmit beam direction, for example, a shape of the beam or a width of the beam at 3 dB.

In addition, it should be noted that the foregoing target information may explicitly indicate the N items of mapping data corresponding to the N parameters (for example, the target information includes the N items of mapping data), or may implicitly indicate the N items of mapping data corresponding to the N parameters.

Step 202: The first device generates a data set according to the plurality of pieces of target information.

Step 203: The first device performs, according to the target identifiers and the data set, at least one of the following: training an artificial intelligence AI unit, performing inference on the AI unit, or monitoring the AI unit.

At least one of the AI unit and the data set is associated with the target identifiers.

The foregoing target information may explicitly indicate the N items of mapping data corresponding to the N parameters, or may implicitly indicate the N items of mapping data corresponding to the N parameters. When the target information explicitly indicates the N items of mapping data, the first device may generate, according to the N items of mapping data, a data set of the AI unit that is associated with the target identifiers after receiving the foregoing first information. When the plurality of pieces of target information implicitly indicate the N items of mapping data, the first device may first obtain the N items of mapping data through calculation according to the target information after receiving the foregoing first information, and then generate, according to the obtained N items of mapping data, the data set of the AI unit that is associated with the target identifiers.

When the data set is used to train the AI unit, the data set includes N items of mapping data, a measurement result related to a functionality of the AI unit, and tag data. Herein, the tag data includes an actual measurement result in a regression problem, or an identifier obtained through processing according to an actual measurement result in a classification problem, where the regression problem refers to inferring a corresponding output value according to an input of the AI unit, which is also referred to as continuous variable prediction. The classification problem refers to inferring a category corresponding to the AI unit according to an input of the AI unit, which is also referred to as discrete variable prediction. In general, the regression problem is approximation prediction for a true value, and the classification problem is to discretize the true value. It can be seen that the output of the AI unit in the regression problem is the measurement result, and the output of the AI unit in the classification problem is an identifier obtained through processing according to an actual measurement result.

When the data set is used for AI inference, the data set includes the N items of mapping data and the measurement result related to the functionality of the AI unit, and the data set is used as the input of the AI unit. Herein, the inference process of the AI unit may include a process of inputting the N items of mapping data and the measurement result related to the functionality of the AI unit to the AI unit, thereby obtaining an output process of the AI unit.

When the data set is used to monitor the AI unit, the data set includes the N items of mapping data and the measurement result related to the functionality of the AI unit, and the data set is used as the input of the AI unit. Therefore, the data set is processed through the AI unit, to obtain the output of the AI unit, and then a monitored data set is generated according to the output of the AI unit and the tag data.

In addition, it should be noted that the AI unit is associated with the target identifiers, which indicates that the input data used when the AI unit is trained is data mapped according to the target data mapping manners indicated by the target identifiers, and the data inputted to the AI unit at an inference phase and a monitoring phase of the AI unit is data mapped according to the target data mapping manners indicated by the target identifiers.

The plurality of pieces of target information are obtained according to the target data mapping manners, and the data set generated according to the plurality of pieces of target information is used in a use process of the AI unit associated with the target identifiers of the target data mapping manners, for example, the training phase, the inference phase, or the monitoring phase.

In addition, that the AI unit is associated with the target identifiers may be specifically that the identifiers of the AI unit is associated with the target identifiers. Optionally, the identifier of the AI unit may be an AI unit identifier, an AI structure identifier, an AI algorithm identifier, an identifier of a specific data set associated with the AI unit, an identifier of a specific scenario, an environment, a channel feature, or a device related to the AI functionality, or an identifier of a functionality, a feature, a capability, or a module related to the AI functionality, which is not specifically limited.

In this embodiment of this application, the first device is a device that performs data collection. The collected data is used for at least one of subsequent training, performing inference, and monitoring the AI unit. The first device may be referred to as a data collection device. The second device cooperates with the first device, and is configured to provide sensitive information of the second device to the first device. In consideration of data security, data mapping needs to be performed on the sensitive information of the second device by the second device, and then the sensitive information of the second device is provided to the first device. The second device may be referred to as an information mapping processing device.

In addition, the AI unit in this embodiment of this application may also be referred to as an AI model, an AI structure, or the like, or the AI unit may also be a processing unit that can implement a specific algorithm, a formula, a processing flow, a capability, or the like related to AI, or the AI unit may be a processing method, an algorithm, a function, a module, or a unit for a specific data set, or the AI unit may be a processing method, an algorithm, a function, a module, or a unit that runs on AI-related hardware such as a graphics processing unit (Graphics Processing Unit, GPU), a neural network processing unit (Neural network Processing Unit, NPU), a tensor processing unit (Tensor Processing Unit, TPU), or an application specific integrated circuit (Application Specific Integrated Circuit, ASIC), which is not specifically limited in this application. Optionally, the specific data set includes at least one of the input of the AI unit and the output of the AI unit.

It may be learned from the foregoing steps 201 to 203 that, in this embodiment of this application, the first device can receive the first information sent by the second device, which includes the target identifier and the target information, and generate the data set according to the plurality of pieces of target information. Herein, the data set is used to perform at least one of “training an AI unit, performing inference on the AI unit, and monitoring the AI unit”, and at least one of the AI unit and the data set is associated with the target identifiers. The plurality of pieces of target information are used to indicate N items of mapping data corresponding to the N parameters of the sensitive information of the second device, the plurality of pieces of target information are obtained by performing data mapping on the N parameters according to the target data mapping manners, and the target identifiers are used to indicate the target data mapping manners.

It may be learned that, in this embodiment of this application, the second device maps the N parameters of the plurality of pieces of sensitive information of the second device according to the target data mapping manners, to obtain the plurality of pieces of target information used for indicating the N items of mapping data corresponding to the N parameters, and sends the plurality of pieces of target information and the target identifiers used for indicating the target data mapping manner to the first device, so that the first device generates, according to the plurality of pieces of target information, the foregoing data set applied to the AI unit. In this way, in a process of using the AI unit, the plurality of pieces of target information of the N items of mapping data corresponding to the N parameters used for indicating the plurality of pieces of sensitive information and the target data mapping manners used for obtaining the plurality of pieces of target information are transmitted between the first device and the second device, rather than directly transmitting the plurality of pieces of sensitive information, thereby avoiding a risk of exposing the plurality of pieces of sensitive information.

In addition, in the prior art, when a UE interacts with a base station, the base station sends a beam privacy indication and virtual beam identifiers, to avoid exposure of the plurality of pieces of sensitive information.

It is assumed that the mapping relationships between the transmit beam directions and the transmit beam physical identifiers are shown in Table 1 below.

TABLE 1
An example of the mapping relationships between the transmit
beam directions and the transmit beam physical identifiers

| Ver- | Horizontal | | | | | | | |
|---|---|---|---|---|---|---|---|---|
| tical | −78.75 | −56.25 | −33.75 | −11.25 | 11.25 | 33.75 | 56.25 | 78.75 |
| 22.5 | 1 | 5 | 9 | 13 | 17 | 21 | 25 | 29 |
| 67.5 | 2 | 6 | 10 | 14 | 18 | 22 | 26 | 30 |
| 112.5 | 3 | 7 | 11 | 15 | 19 | 23 | 27 | 31 |
| 157.5 | 4 | 8 | 12 | 16 | 20 | 24 | 28 | 32 |

A disordered operation is performed on the mapping relationship shown in Table 1 above, so that the mapping relationships between the transmit beams and the virtual beam identifiers may be obtained, as shown in Table 2.

TABLE 2
An example of mapping relationships between the transmit
beam directions and the virtual beam identifiers

| Ver- | Horizontal | | | | | | | |
|---|---|---|---|---|---|---|---|---|
| tical | −78.75 | −56.25 | −33.75 | −11.25 | 11.25 | 33.75 | 56.25 | 78.75 |
| 22.5 | 23 | 1 | 26 | 8 | 22 | 32 | 6 | 15 |
| 67.5 | 17 | 4 | 20 | 7 | 14 | 28 | 9 | 5 |
| 112.5 | 29 | 25 | 12 | 11 | 27 | 13 | 24 | 30 |
| 157.5 | 3 | 19 | 16 | 21 | 31 | 2 | 10 | 18 |

Then, when configuring a measurement resource, the base station sends, to the UE, the virtual beam identifiers that are associated with the measurement resource processed in Table 2 and the privacy processing identifiers or the data set identifiers associated with Table 2.

If the base station directly sends the mapped beam identifiers to the UE according to Table 1, the beam identifiers expose relative relationships of some beam directions. For example, vertical angles indicated by identifiers 1-4 are in an ascending order. In contrast, after mapping is performed according to Table 2, if the virtual beam identifiers are sent to the UE, the identifiers 1-4 cannot indicate ascending sequence information between vertical beam angles or horizontal beam angles, thereby better protecting the plurality of pieces of sensitive information of the beam directions.

However, in a method (for example, the processing method from Table 1 to Table 2) of performing privacy processing on a mixture of the beams in a horizontal dimension and a vertical dimension of the base station and mapping to obtain the virtual identifiers, relative relationships between the beams are excessively lost, causing degradation of prediction performance.

However, in the data collection method in this embodiment of this application, when data mapping is performed on the horizontal direction and the vertical direction (or physical identifiers in the horizontal direction and physical identifiers in the vertical direction) of the transmit beam directions of the second device, data mapping is respectively performed on two dimensions of the horizontal direction and the vertical direction, to obtain a plurality of pieces of target information that can indicate horizontal direction mapping data and vertical direction mapping data, instead of mixing the horizontal dimension and the vertical dimension to perform privacy. Therefore, in this embodiment of this application, privacy processing is respectively performed on the two dimensions of the transmit beam, namely, the horizontal dimension and the vertical dimension, to help reserve relative relationships between some beams and help the terminal extract a feature of the transmit beams, thereby improving accuracy of beam prediction and ensuring that the sensitive information of the beams is not exposed.

Manners of performing data mapping on the N parameters according to the target data mapping manners to obtain the plurality of pieces of target information are specifically described in Implementation 1 or Implementation 2 below.

Implementation 1: Optionally, the plurality of pieces of target information include the N items of mapping data, the target data mapping manners include N first data mapping manners, and an i^{th} mapping data is an i^{th} parameter in the plurality of pieces of sensitive information and is obtained through the i^{th} first data mapping manner, where i is an integer ranging from 1 to N.

It may be understood that the N first data mapping manners may be the same, or may be different.

When the N first data mapping manners are the same, the target data mapping manners includes first data mapping manners, and data mapping is performed on all N parameters through the first data mapping manners, to obtain the N items of mapping data; and when the N first data mapping manners are different, data mapping is performed on the i^{th} parameter through the i^{th} first data mapping manner, to obtain the i^{th} mapping data.

For example, when the N parameters include a horizontal direction and a vertical direction of a transmit beam of the second device, data mapping may be performed on the horizontal direction (or a physical identifier in the horizontal direction) and the vertical direction (or a physical identifier in the vertical direction) through a same first data mapping manner, to obtain mapping data corresponding to the horizontal direction and mapping data corresponding to the vertical direction.

The mapping data corresponding to the horizontal direction is used to indicate the horizontal direction, and the mapping data corresponding to the vertical direction is used to indicate the vertical direction. Therefore, the mapping data corresponding to the horizontal direction may also be referred to as a horizontal virtual identifier, and the mapping data corresponding to the vertical direction is used to indicate the vertical direction and may also be referred to as a vertical virtual identifier.

Using an example in which the N parameters are physical identifiers in the horizontal direction and physical identifiers in the vertical direction, the N items of mapping data include the horizontal virtual identifiers and the vertical virtual identifiers, and the N first data mapping manners are the same below, Implementation 1 is explained according to the following example.

It is assumed that mapping relationships between the horizontal direction and the physical identifiers are shown in Table 3 below.

TABLE 3
An example of the mapping relationships between the
horizontal direction and the physical identifiers

| Horizontal direction | −78.75 | −56.25 | −33.75 | −11.25 | 11.25 | 33.75 | 56.25 | 78.75 |
|---|---|---|---|---|---|---|---|---|
| Physical identifier | 1 | 2 | 3 | 4 | 5 | 6 | 7 | 8 |

However, after the physical identifiers of the horizontal direction in Table 1 are processed through the first data mapping manner (for example, a randomly disrupted order), the mapping relationship between the horizontal direction and the horizontal virtual identifier is shown in Table 4 below.

TABLE 4
An example of the mapping relationships between the horizontal
direction and the horizontal virtual identifiers

| Horizontal direction | −78.75 | −56.25 | −33.75 | −11.25 | 11.25 | 33.75 | 56.25 | 78.75 |
|---|---|---|---|---|---|---|---|---|
| Virtual identifier | 6 | 1 | 5 | 3 | 7 | 2 | 8 | 4 |

It is assumed that mapping relationships between the vertical direction and the physical identifiers are shown in Table 5 below.

TABLE 5
An example of the mapping relationships between the
vertical direction and the physical identifiers

| Horizontal direction | 22.5 | 67.5 | 112.5 | 157.5 |
|---|---|---|---|---|
| Physical identifier | 1 | 2 | 3 | 4 |

However, after the physical identifiers in the vertical direction in Table 5 are processed through the first data mapping manner (for example, a randomly disrupted order), the mapping relationships between the vertical direction and the vertical virtual identifier are shown in Table 6 below.

TABLE 6
An example of the mapping relationships between the vertical
direction and the vertical virtual identifiers

| Horizontal direction | 22.5 | 67.5 | 112.5 | 157.5 |
|---|---|---|---|---|
| Virtual identifier | 2 | 3 | 4 | 1 |

It can be seen that mapping is performed on (horizontal direction, vertical direction)=(−33.75, 67.5) or (a horizontal physical identifier, a vertical physical identifier)=(3, 2) of the beam direction of the base station through the first data mapping manner, to obtain (a virtual horizontal identifier, a virtual vertical identifier)=(5, 3), where 5 is a horizontal virtual identifier, and 3 is a vertical virtual identifier.

Implementation 2: Optionally, the target information includes first data and second information, and the second information is used to indicate mapping relationships between the first data and the N items of mapping data.

That the first device generates a data set according to the plurality of pieces of target information includes:

The first device determines the N items of mapping data according to the mapping relationships indicated by the second information and the first data.

The first device generates the data set according to the N items of mapping data.

Herein, the first data is one-dimensional data obtained by mapping N-dimensional data formed by the N items of mapping data, the N items of mapping data are obtained by the N parameters of the sensitive information respectively through the second data mapping manners, the second information is used to indicate mapping relationships between the first data and the N items of mapping data, and i^{th} mapping data corresponds to an i^{th} parameter in the plurality of pieces of sensitive information, where i is an integer ranging from 1 to N.

It may be learned that the second device may further perform data mapping on the N parameters through the second data mapping manner to obtain the N items of mapping data, and then convert the N-dimensional data formed by the N items of mapping data into the one-dimensional data to obtain the first data, so as to send the first data and the second information used for indicating the mapping relationship between the first data and the N items of mapping data to the first device.

The first data is obtained by converting the N-dimensional data formed by the N items of mapping data. Therefore, a mapping relationship exists between the N items of mapping data and the first data. It can be learned that after obtaining the N items of mapping data, the second device may not directly send the N items of mapping data to the first device, but send the first data and the second information used for indicating the mapping relationship between the first data and the N items of mapping data. In this way, the first device may determine the N items of mapping data according to the mapping relationships indicated by the second information and the first data.

For example, when the N parameters include the horizontal direction and the vertical direction of the transmit beam of the second device, the second device may perform data mapping on the horizontal direction (or the physical identifier in the horizontal direction) and the vertical direction (or the physical identifier in the vertical direction) through the second data mapping manner, to obtain the horizontal virtual identifier and the vertical virtual identifier. Then, the second device converts the two-dimensional data formed by the horizontal virtual identifier and the vertical virtual identifier into the one-dimensional data, to obtain the first data, which may also be referred to as a target virtual identifier. Therefore, the second device sends the target virtual identifier and the second information used for indicating the mapping relationship between the target virtual identifier and the horizontal virtual identifier and the vertical virtual identifier to the first device. In this way, the first device may obtain the horizontal virtual identifier and the vertical virtual identifier according to the mapping relationship and the target virtual identifier.

Optionally, the second information includes a reference parameter, a quantity of values of the reference parameter, and a functional relationship between the first data and the N items of mapping data; and the reference parameter is at least some of the N parameters.

Herein, the quantity of values of the reference parameter and the first data are variables in the foregoing functional relationship. Therefore, the quantity of values of the reference parameter and the first data are substituted into the functional relationship between the first data and the N items of mapping data, to obtain the N items of mapping data through calculation.

Implementation 2 above is explained by using an example in which the N parameters are the physical identifier in the horizontal direction and the physical identifiers in the vertical direction, the N items of mapping data include the horizontal virtual identifiers and the vertical virtual identifiers, and the one-dimensional first data is the target virtual identifiers below.

For example, mapping is performed on (horizontal direction, vertical direction)=(−33.75, 67.5) of the beam direction of the base station through the second data mapping manner, to obtain (a virtual horizontal identifier, a virtual vertical identifier)=(5, 3), where 5 is a horizontal virtual identifier, and 3 is a vertical virtual identifier.

In this case, if the reference parameter is the vertical direction and the quantity of values of the reference parameter is 4, the base station side calculates the foregoing target virtual identifier as follows: (the horizontal virtual identifier−1)*the quantity of values of the reference parameter+the vertical virtual identifier=(5−1)*4+3=19.

Assuming that the calculation formula is agreed on by the terminal and two sides of the base station in advance, the terminal may solve the horizontal virtual identifier and the vertical virtual identifier according to the received target virtual identifier 19 and a conversion form of the foregoing formula:

$$the horizontal virtual identifier = ceil ( the target virtual identifier / the quantity of values of the reference parameter ) = ceil ( 19 / 4 ) = 5 , and$$

$$the vertical virtual identifier = the target virtual identifier - the horizontal virtual identifier * the quantity of values of the reference parameter = 3 , where$$

$$ceil ( 19 / 4 ) represents rounding up to an integer .$$

Optionally, before the first device receives first information sent by the second device, the method further includes:

The first device sends third information to the second device, where
the third information includes the target identifiers and a plurality of pieces of target indication information, and the plurality of pieces of target indication information are used to indicate that data mapping is respectively performed on the N parameters.

It may be learned that the first device may further send the third information including the target identifiers and the plurality of pieces of target indication information to the second device, to inform the second device of a data collection requirement of the first device, so that the second device may perform data mapping on the N parameters of the plurality of pieces of sensitive information of the second device according to a requirement indicated by the plurality of pieces of target indication information through target data mapping manners indicated by the target identifiers.

Optionally, at an inference phase, a monitoring phase, and an identification (or registration) phase of the AI unit, the first device sends the foregoing third information to the second device.

Optionally, when the target data mapping manners include the N first data mapping manners, the plurality of pieces of target indication information include a plurality of pieces of first indication information, the plurality of pieces of first indication information are used to indicate that the N parameters are respectively mapped to the N items of mapping data through the N first data mapping manners.

When the target data mapping manners include second data mapping manners, the plurality of pieces of target indication information include a plurality of pieces of second indication information, and the plurality of pieces of second indication information are used to indicate that the N parameters are respectively mapped to the N items of mapping data through the second data mapping manners, and then N-dimensional data formed by the N items of mapping data is mapped to one-dimensional data.

The foregoing first indication information may also be referred to as a first condition, a first additional condition, or a first model use condition. The foregoing second indication information may also be referred to as a second condition, a second additional condition, or a second model use condition.

It may be learned that according to Implementation 1 above, if the N first data mapping manners are the same, the first device may send a first identifier used for indicating the first data mapping manner to the second device, and instruct, through the first indication information, the second device to use the first data mapping manner indicated by the first identifier. If the N first data mapping manners are different, the first device may send identifiers used for indicating the N first data mapping manners to the second device, and instruct, through the first indication information, the second device to use the N first data mapping manners.

According to Implementation 2 above, the first device may send a second identifier used for indicating the second data mapping manner to the second device, and instruct, through the second indication information, the second device to use the second data mapping manner indicated by the second identifier.

It should be noted that in Implementation 2 above, the first device may alternatively not send the first indication information. In this way, after receiving the identifiers used for indicating the N first data mapping manners, the second device respectively maps the N parameters to the N items of mapping data through the N first data mapping manners by default.

For the solution in Implementation 1 above in which the N first data mapping manners are the same and the solution in Implementation 2 above, one data mapping manner is used. In this case, the third information (for example, a required information) sent by the first device to the second device includes an identifier used for indicating the data mapping manner. Therefore, to distinguish the two solutions, how to use the data mapping manner indicated by the identifier may further be indicated through the foregoing first indication information or the second indication information.

Optionally, the method further includes:

The first device sends capability information to the second device when the first device is a terminal device, where the capability information is used to indicate that the terminal device supports first processing manners or second processing manners;
the first processing manners are manners of mapping the N parameters to the N items of mapping data; and
the second processing manners are manners of mapping the N parameters to the N items of mapping data, and then mapping the N items of mapping data to the one-dimensional data.

It may be learned that the first device may further report to the second device which one of the foregoing first processing manner and the second processing manner is supported by the first device, so that the second device may perform data mapping on the N parameters of the second device through the processing manner supported by the first device.

The first processing manner may also be referred to as configuration of the N-dimensional identifier, and the second processing manner may also be referred to as configuration of the one-dimensional identifier.

Optionally, the foregoing first data mapping manner or the second data mapping manner includes any one of the following:
offsetting data;
scaling the data;
performing a polynomial functionality change on the data;
performing multidimensional mapping on a single data item, to obtain a plurality of items of data;
performing a disordered operation on a group of data; and
performing quantization and mapping on a single data item.

According to a second aspect, as shown in FIG. 3, an embodiment of this application provides a data collection method. The method is performed by a second device, the second device may be a base station, and the method includes the following steps.

Step 301: The second device performs data mapping on N parameters its plurality of pieces of sensitive information according to a target data mapping manner, to obtain target information.

The target information is used to indicate N items of mapping data corresponding to the N parameters, or the target information is used to represent the N items of mapping data corresponding to the N parameters.

Step 302: The second device sends first information to the first device.

The first information includes the plurality of pieces of target information and target identifiers, the target identifiers are used to indicate the target data mapping manners, and the N items of mapping data are used to generate a data set.

The data set is used to perform at least one of the following:
training an artificial intelligence AI unit, where at least one of the AI unit and the data set is associated with the target identifiers;
performing inference on the AI unit; or
monitoring the AI unit.

In addition, after receiving the foregoing first information, the first device generates, according to the target information, a data set of the AI unit that is associated with the target identifier.

It can be seen that the N parameters of the sensitive information of the second device are mapped according to the target data mapping manner, to obtain the plurality of pieces of target information used for indicating (or representing) the N items of mapping data corresponding to the N parameters. In this way, what the second device sends to the first device is no longer actual N parameters, but the mapped target information. Therefore, even if a peer end receives the plurality of pieces of target information, the actual N parameters cannot be obtained according to the target information. Therefore, the plurality of pieces of target information are used as privacy information of the N parameters of the second device herein, and the target data mapping manners may also be referred to as data privacy methods.

Optionally, the plurality of pieces of sensitive information include transmit beam directions, and the N parameters include N direction dimensions of the transmit beam directions. The N dimensions may include a horizontal direction and a vertical direction.

The second device may perform, according to the target data mapping manners, data mapping on the N direction dimensions (for example, the horizontal direction and the vertical direction) of the transmit beam direction of the second device, to obtain the plurality data of the N direction dimensions. In this way, what is transmitted between the first device and the second device is no longer the actual beam directions, but the mapping data (for example, privacy data) of the beam directions, thereby avoiding exposure of the actual beam direction and improving data security.

It should be noted that when data mapping is performed on the N direction dimensions according to the target data mapping manners, data mapping may be performed on angles of the N direction dimensions, or data mapping may be performed on physical identifiers of the N direction dimensions.

It may be understood that the plurality of pieces of sensitive information may further include another information other than the transmit beam directions, for example, a shape of the beam or a width of the beam at 3 dB.

In addition, it should be noted that the foregoing target information may explicitly indicate the N items of mapping data corresponding to the N parameters (for example, the target information includes the N items of mapping data), or may implicitly indicate the N items of mapping data corresponding to the N parameters. Therefore, when the target information explicitly indicates the N items of mapping data, the first device may generate, according to the N items of mapping data, a data set of the AI unit that is associated with the plurality of pieces of target identifier after receiving the foregoing first information. When the target information implicitly indicates the N items of mapping data, the first device may first obtain the N items of mapping data through calculation according to the plurality of pieces of target information after receiving the foregoing first information, and then generate, according to the obtained N items of mapping data, the data set of the AI unit that is associated with the target identifiers.

In addition, the AI unit is associated with the target identifier, which indicates that the input data used when the AI unit is trained is data mapped according to the target data mapping manners indicated by the target identifiers, and the data inputted to the AI unit at an inference phase and a monitoring phase of the AI unit is data mapped according to the target data mapping manners indicated by the target identifiers.

The plurality of pieces of target information are obtained according to the target data mapping manners, and the data set generated according to the plurality of pieces of target information are used in a use process of the AI unit associated with the target identifiers of the target data mapping manners, for example, the training phase, the inference phase, or the monitoring phase.

It may be learned from steps 301 to 302 above that, in this embodiment of this application, the second device maps the N parameters of the sensitive information of the second device according to the target data mapping manners, to obtain the plurality of pieces of target information used for indicating (representing) the N items of mapping data corresponding to the N parameters, and sends the plurality of pieces of target information and the target identifiers used for indicating the target data mapping manners to the first device, so that the first device generates, according to the plurality of pieces of target information, the foregoing data set applied to the AI unit. In this way, in a process of using the AI unit, the plurality of pieces of target information of the N items of mapping data corresponding to the N parameters used for indicating the plurality of pieces of sensitive information and the target data mapping manners used for obtaining the plurality of pieces of target information are transmitted between the first device and the second device, rather than directly transmitting the plurality of pieces of sensitive information, thereby avoiding a risk of exposing the plurality of pieces of sensitive information.

Manners of performing data mapping on the N parameters according to the target data mapping manners to obtain the plurality of pieces of target information are specifically described in Implementation 1 or Implementation 2 below.

Implementation 1: Optionally, the target data mapping manners includes N first data mapping manners.

That a second device performs data mapping on N parameters of its plurality of pieces of sensitive information according to target data mapping manners, to obtain a plurality of pieces of target information includes:

The second device performs data mapping on an i^{th} parameter among the N parameters through an i^{th} first data mapping manner, to obtain i^{th} mapping data, where i is an integer ranging from 1 to N.

The second device determines the obtained N items of mapping data as the target information.

It may be understood that the N first data mapping manners may be the same, or may be different. When the N first data mapping manners are the same, data mapping is performed on all N parameters through the same first data mapping manner, to obtain the N items of mapping data. When the N first data mapping manners are different, data mapping is performed on the i^{th} parameter through the i^{th} first data mapping manner, to obtain the i^{th} mapping data.

For example, when the N parameters include a horizontal direction and a vertical direction of a transmit beam of the second device, data mapping may be performed on the horizontal direction (or a physical identifier in the horizontal direction) and the vertical direction (or a physical identifier in the vertical direction) through a same first data mapping manner, to obtain mapping data corresponding to the horizontal direction and mapping data corresponding to the vertical direction.

The mapping data corresponding to the horizontal direction is used to indicate the horizontal direction, and the mapping data corresponding to the vertical direction is used to indicate the vertical direction. Therefore, the mapping data corresponding to the horizontal direction may also be referred to as a horizontal virtual identifier, and the mapping data corresponding to the vertical direction is used to indicate the vertical direction and may also be referred to as a vertical virtual identifier.

Implementation 2: Optionally, the target data mapping manner includes a second data mapping manner.

That a second device performs data mapping on N parameters of its plurality of pieces of sensitive information according to target data mapping manners, to obtain a plurality of pieces of target information includes:

The second device respectively performs data mapping on the N parameters through the second data mapping manner, to obtain the N items of mapping data.

The second device maps N-dimensional data formed by the N items of mapping data to one-dimensional data, to obtain first data.

The second device determines the first data and second information as the plurality of pieces of target information, where the plurality of pieces of second information are used to indicate mapping relationships between the first data and the N items of mapping data.

It may be learned that the second device may further perform data mapping on the N parameters through the second data mapping manners to obtain the N items of mapping data, and then convert the N-dimensional data formed by the N items of mapping data into the one-dimensional data to obtain the first data, so as to send the first data and the second information used for indicating the mapping relationships between the first data and the N items of mapping data to the first device.

The first data is obtained by converting the N-dimensional data formed by the N items of mapping data. Therefore, mapping relationships exist between the N items of mapping data and the first data. It can be learned that after obtaining the N items of mapping data, the second device may not directly send the N items of mapping data to the first device, but send the first data and the second information used for indicating the mapping relationships between the first data and the N items of mapping data.

For example, when the N parameters include the horizontal direction and the vertical direction of the transmit beam of the second device, the second device may perform data mapping on the horizontal direction (or the physical identifier in the horizontal direction) and the vertical direction (or the physical identifier in the vertical direction) through the second data mapping manner, to obtain the horizontal virtual identifier and the vertical virtual identifier. Then, the second device converts the two-dimensional data formed by the horizontal virtual identifier and the vertical virtual identifier into the one-dimensional data, to obtain the first data, which may also be referred to as target virtual identifiers. Therefore, the second device sends the target virtual identifiers and the second information used for indicating the mapping relationships between the target virtual identifiers and the horizontal virtual identifiers and the vertical virtual identifiers to the first device.

Optionally, the second information includes a reference parameter, a quantity of values of the reference parameter, and a functional relationship between the first data and the N items of mapping data; and
the reference parameter is at least some of the N parameters.

Herein, the reference parameter and the quantity of values of the reference parameter are substituted into the functional relationship between the first data and the N items of mapping data, to obtain the N items of mapping data through calculation.

Optionally, before a second device performs data mapping on N parameters of its plurality of pieces of sensitive information according to target data mapping manners, to obtain a plurality of pieces of target information, the method further includes the following step.

The second device receives third information sent by the first device, where the third information includes the target identifiers and a plurality of pieces of target indication information, and the plurality of pieces of target indication information are used to indicate that data mapping is respectively performed on the N parameters.

That a second device performs data mapping on N parameters of its plurality of pieces of sensitive information according to target data mapping manners, to obtain a plurality of pieces of target information includes:

The second device performs, according to the target indication information, data mapping on the N parameters through the target data mapping manner indicated by the target identifier, to obtain the target information.

It may be learned that the first device may further send the third information including the target identifier and the target indication information to the second device, to inform the second device of a data collection requirement of the first device, so that the second device may perform data mapping on the N parameters of the sensitive information of the second device according to a requirement indicated by the target indication information through a target data mapping manner indicated by the target identifier.

Optionally, at an inference phase, a monitoring phase, and an identification (or registration) phase of the AI unit, the first device sends the foregoing third information to the second device.

Optionally, when the target data mapping manners include the N first data mapping manners, the plurality of pieces of target indication information include a plurality of pieces of first indication information, the plurality of pieces of first indication information are used to indicate that the N parameters are respectively mapped to the N items of mapping data through the N first data mapping manners.

When the target data mapping manner includes a second data mapping manner, the target indication information includes second indication information, and the second indication information is used to indicate that the N parameters are respectively mapped to the N items of mapping data through the second data mapping manner, and then N-dimensional data formed by the N items of mapping data is mapped to one-dimensional data.

The foregoing first indication information may also be referred to as a first additional condition or a first model use condition. The foregoing second indication information may also be referred to as a second additional condition or a second model use condition.

It may be learned that according to Implementation 1 above, if the N first data mapping manners are the same, the first device may send a first identifier used for indicating the first data mapping manner to the second device, and instruct, through the first indication information, the second device to use the first data mapping manner indicated by the first identifier. If the N first data mapping manners are different, the first device may send identifiers used for indicating the N first data mapping manners to the second device, and instruct, through the first indication information, the second device to use the N first data mapping manners.

According to Implementation 2 above, the first device may send a second identifier used for indicating the second data mapping manner to the second device, and instruct, through the second indication information, the second device to use the second data mapping manner indicated by the second identifier.

It should be noted that in Implementation 2 above, the first device may alternatively not send the first indication information. In this way, after receiving the identifiers used for indicating the N first data mapping manners, the second device respectively maps the N parameters to the N items of mapping data through the N first data mapping manners by default.

For the solution in Implementation 1 above in which the N first data mapping manners are the same and the solution in Implementation 2 above, one data mapping manner is used. In this case, the third information (for example, a required information) sent by the first device to the second device includes an identifier used for indicating the data mapping manner. Therefore, to distinguish the two solutions, how to use the data mapping manner indicated by the identifier further needs to be indicated through the foregoing first indication information or the second indication information.

Optionally, the method further includes:

The second device receives capability information sent by the first device when the first device is a terminal device, where the capability information is used to indicate that the terminal device supports first processing manners or second processing manners;
the first processing manners are manners of mapping the N parameters to the N items of mapping data, and then mapping the N items of mapping data to the one-dimensional data; and
the second processing manners are manners of mapping the N parameters to the N items of mapping data.

It may be learned that the first device may further report to the second device which one of the foregoing first processing manner and the second processing manner is supported by the first device, so that the second device may perform data mapping on the N parameters of the second device through the processing manners supported by the first device.

The first processing manner may also be referred to as configuration of the N-dimensional identifier, and the second processing manner may also be referred to as configuration of the one-dimensional identifier.

According to the above, a specific implementation of the data collection method in embodiments of this application may be as described below.

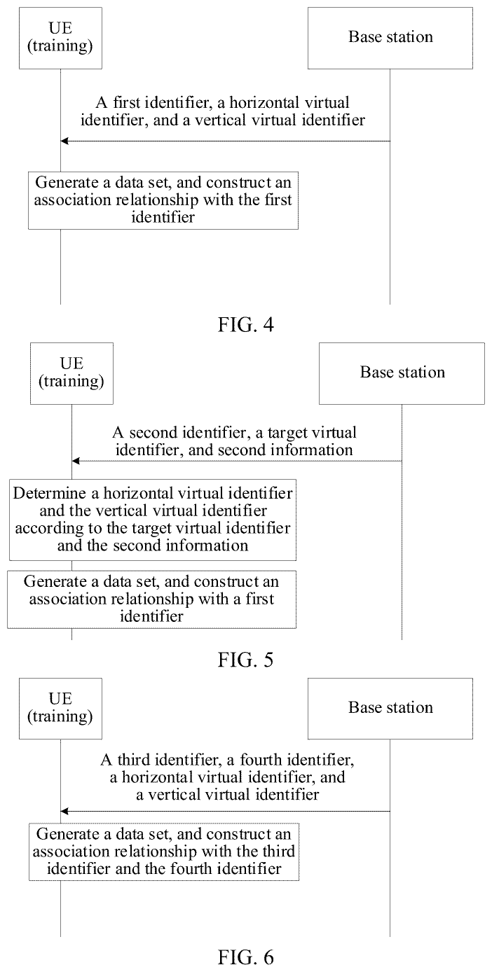

Implementation 1-1: The data collection during training, as shown in FIG. 4, includes step 1-1.1 to step 1-1.3 below.

Step 1-1.1: A UE receives first information sent by a base station, where the first information includes a first identifier, a horizontal virtual identifier associated with a measurement resource, and a vertical virtual identifier associated with the measurement resource.

Herein, the first identifier is used to indicate a first data mapping manner, and the horizontal virtual identifier is obtained by a horizontal direction (or a physical identifier in a horizontal direction) of a transmit beam of the base station through the first data mapping manner. The vertical virtual identifier is obtained by a vertical direction (or a physical identifier in a vertical direction) of the transmit beam of the base station through the first data mapping manner.

Step 1-1.2: The UE generates, according to the horizontal virtual identifier and the vertical virtual identifier associated with the measurement resource, a data set for training by an AI unit associated with the first identifier.

Herein, the data set includes the horizontal virtual identifier associated with the measurement resource, the vertical virtual identifier associated with the measurement resource, a measurement result associated with the measurement resource, and tag data.

The measurement result includes at least one of the following:
a reference signal receiving power (Reference Signal Receiving Power, RSRP);
reference signal receiving quality (Reference Signal Receiving Quality, RSRQ);
a signal to interference plus noise ratio (Signal to Interference plus Noise Ratio, SINR); and
a wireless channel.

The tag data includes at least one of the followings:
beam quality information (for example, RSRP, RSRQ, or SINR);
a beam identifier having the strongest beam quality;
a probability distribution of the beam identifier having the strongest beam quality; and
a confidence score.

Step 1-1.3: The UE establishes an association relationship between the data set and the first identifier.

Embodiment 1-2: The data collection during training, as shown in FIG. 5, includes step 1-2.1 to step 1-2.4 below.

Step 1-2.1: A UE receives the first information sent by a base station, where the first information includes a second identifier, a target virtual identifier associated with the measurement resource, and second information.

Herein, the second identifier is used to indicate a second data mapping manner, the target virtual identifier is one-dimensional data obtained by mapping two-dimensional data formed by a horizontal virtual identifier and the vertical virtual identifier, and the horizontal virtual identifier is obtained by a horizontal direction (or a physical identifier in a horizontal direction) of a transmit beam of the base station through the second data mapping manner. The vertical virtual identifier is obtained by a vertical direction (or a physical identifier in a vertical direction) of the transmit beam of the base station through the second data mapping manner.

In addition, a mapping relationship exists between the target virtual identifier and the horizontal virtual identifier and the vertical virtual identifier. The second information is used to indicate the mapping relationship. Therefore, the second information is used to indicate splitting the one-dimensional data of the target virtual identifier into two-dimensional data formed by the horizontal virtual identifier and the vertical virtual identifier, so that the second information may also be referred to as a two-dimensional splitting indication.

The foregoing second information is used to indicate a reference parameter, a quantity of values of the reference parameter, and a functional relationship between the target virtual identifier and the horizontal virtual identifier and the vertical virtual identifier. The reference parameter is one of the horizontal direction and the vertical direction. For example, when the reference parameter is the horizontal direction, the quantity of values of the reference parameter is a quantity of the horizontal direction. When the reference parameter is the vertical direction, the quantity of values of the reference parameter is a quantity of the vertical direction.

Step 1-2.2: The UE determines the horizontal virtual identifier and the vertical virtual identifier according to the target virtual identifier and the second information.

Step 1-2.3: The UE generates, according to the horizontal virtual identifier and the vertical virtual identifier, a data set for training by the AI unit associated with the second identifier.

Herein, the data set includes the horizontal virtual identifier associated with the measurement resource, the vertical virtual identifier associated with the measurement resource, a measurement result associated with the measurement resource, and tag data.

Step 1-2.4: The UE establishes an association relationship between the data set and the second identifier.

Implementation 1-3: The data collection during training, as shown in FIG. 6, includes step 1-3.1 to step 1-3.3 below.

Step 1-3.1: A UE receives first information sent by a base station, where the first information includes a third identifier, a fourth identifier, a horizontal virtual identifier associated with a measurement resource, and a vertical virtual identifier associated with the measurement resource.

The third identifier and the fourth identifier are used to indicate different data mapping manners, for example, respectively indicate a third data mapping manner and a fourth data mapping manner. In this case, the horizontal virtual identifier is obtained by a horizontal direction (or a physical identifier in a horizontal direction) of a transmit beam of the base station through the third data mapping manner. The vertical virtual identifier is obtained by a vertical direction (or a physical identifier in a vertical direction) of the transmit beam of the base station through the fourth data mapping manner.

Step 1-3.2: The UE generates, according to the horizontal virtual identifier associated with the measurement resource and the vertical virtual identifier associated with the measurement resource, a data set for training by an AI unit associated with the third identifier and the fourth identifier.

Herein, the data set includes the horizontal virtual identifier associated with the measurement resource, the vertical virtual identifier associated with the measurement resource, a measurement result associated with the measurement resource, and tag data.

Step 1-3.3: The UE establishes an association relationship between the data set and the third identifier and the fourth identifier.

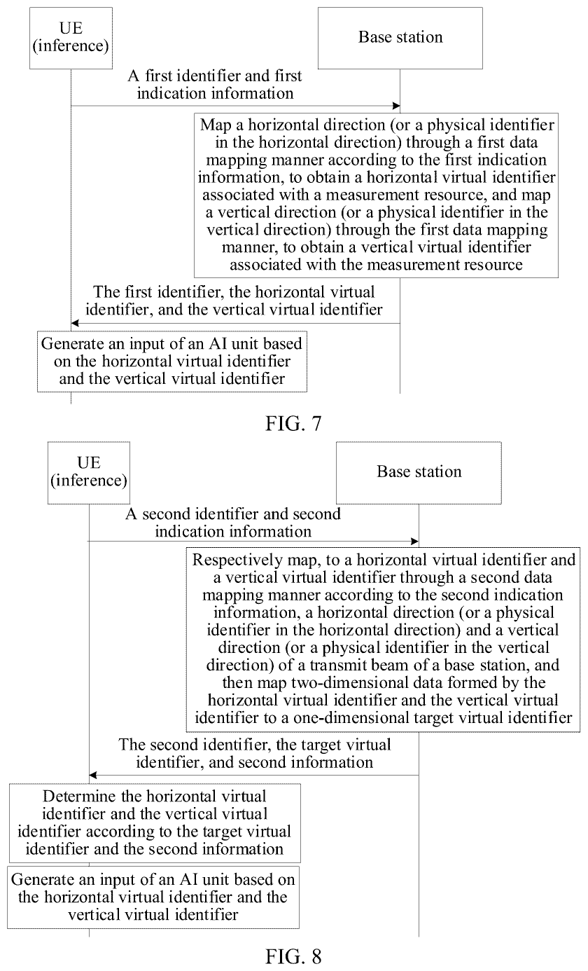

Implementation 2-1: The data collection during inference, as shown in FIG. 7, includes step 2-1.1 to step 2-1.5 below.

Step 2-1.1: The UE sends third information to the base station, where the third information is used to indicate a data collection requirement when the UE performs inference on an AI unit, and the third information includes a first identifier and first indication information.

Herein, the first identifier is used to indicate a first data mapping manner, and the first indication information is used to indicate that a horizontal direction (or a physical identifier in a horizontal direction) and a vertical direction (or a physical identifier in a vertical direction) of a transmit beam of the base station are respectively mapped to a horizontal virtual identifier and a vertical virtual identifier through the first data mapping manner.

It should be noted that if the UE and the base station have exchanged the first identifier and the first indication information in the model identification exchange phase, step 2-1.1 may not be needed.

Step 2-1.2: The base station maps the horizontal direction (or the physical identifier in the horizontal direction) through the first data mapping manner according to the first indication information, to obtain a horizontal virtual identifier associated with the measurement resource, and maps the vertical direction (or the physical identifier in the vertical direction) through the first data mapping manner, to obtain a vertical virtual identifier associated with the measurement resource.

It may be learned from step 2-1.2 that, in this implementation, the horizontal virtual identifier and the vertical virtual identifier are mapped and obtained through a same data mapping manner. Therefore, if the first information sent by the UE to the base station includes only an identifier used for indicating the data mapping manner, the first indication information may further be used to instruct the base station to specifically perform data mapping through the data mapping manner indicated by the identifier.

Step 2-1.3: The base station sends first information to the UE, where the first information includes a first identifier, a horizontal virtual identifier associated with a measurement resource, and a vertical virtual identifier associated with the measurement resource.

Step 2-1.4: The UE receives the first information send by the base station.

Step 2-1.5: The UE generates, according to the horizontal virtual identifier and the vertical virtual identifier associated with the measurement resource, a data set (as an input for generating the AI unit) used for inference by the AI unit.

The UE uses the horizontal virtual identifier associated with the measurement resource, the vertical virtual identifier associated with the measurement resource, and the measurement result associated with the measurement resource as the input for inference by the AI unit associated with the first identifier.

Implementation 2-2: The data collection during inference, as shown in FIG. 8, includes Step 2-2.1 to Step 2-2.5 below.

Step 2-2.1: A UE sends third information to a base station, where the third information is used to indicate a data collection requirement when the UE performs inference on an AI unit, and the third information includes a second identifier and second indication information.

Herein, the second identifier is used to indicate a second data mapping manner, and the second indication information is used to indicate that the horizontal direction (or a physical identifier in a horizontal direction) and the vertical direction (or a physical identifier in a vertical direction) of the transmit beam of the base station are respectively mapped to a horizontal virtual identifier and a vertical virtual identifier through the second data mapping manner, and then two-dimensional data formed by the horizontal virtual identifier and the vertical virtual identifier is mapped to a one-dimensional target identifier.

It should be noted that if the UE and the base station have exchanged the second identifier and the second indication information in the model identification exchange phase, step 2-2.1 may not be needed.

Step 2-2.2: The base station respectively maps, to the horizontal virtual identifier and the vertical virtual identifier through the second data mapping manner according to the second indication information, the horizontal direction (or the physical identifier in the horizontal direction) and the vertical direction (or the physical identifier in the vertical direction) of the transmit beam of the base station, and then maps the two-dimensional data formed by the horizontal virtual identifier and the vertical virtual identifier to the one-dimensional target virtual identifier.

Step 2-2.3: The base station sends first information to the UE, where the first information includes a second identifier, a target virtual identifier, and second information.

A mapping relationship exists between the target virtual identifier and the horizontal virtual identifier and the vertical virtual identifier. The second information is used to indicate the mapping relationship. Therefore, the second information is used to indicate splitting the one-dimensional data of the target virtual identifier into two-dimensional data formed by the horizontal virtual identifier and the vertical virtual identifier, so that the second information may also be referred to as a two-dimensional splitting indication.

In addition, the second information is used to indicate a reference parameter, a quantity of values of the reference parameter, and a functional relationship between the target virtual identifier and the horizontal virtual identifier and the vertical virtual identifier. The reference parameter is one of the horizontal direction and the vertical direction. For example, when the reference parameter is the horizontal direction, the quantity of values of the reference parameter is a quantity of the horizontal direction. When the reference parameter is the vertical direction, the quantity of values of the reference parameter is a quantity of the vertical direction.

Step 2-2.4: The UE determines the horizontal virtual identifier and the vertical virtual identifier according to the target virtual identifier and the second information.

Step 2-2.5: The UE generates, according to the horizontal virtual identifier and the vertical virtual identifier, a data set (as an input for generating the AI unit) used for inference by the AI unit.

The UE uses the horizontal virtual identifier associated with the measurement resource, the vertical virtual identifier associated with the measurement resource, and the measurement result associated with the measurement resource as the input for inference by the AI unit.

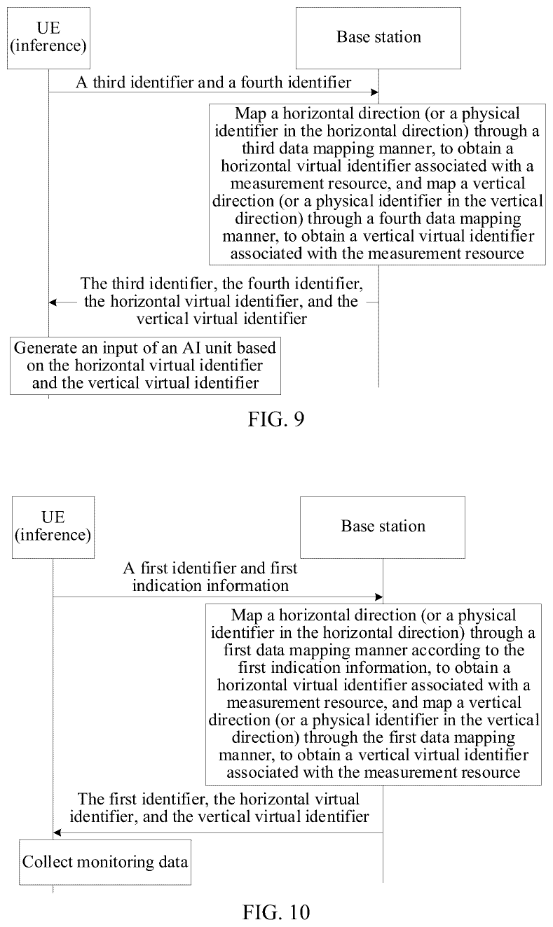

Implementation 2-3: The data collection during inference, as shown in FIG. 9, includes step 2-3.1 to step 2-3.4 below.

Step 2-3.1: A UE sends third information to a base station, where the third information is used to indicate a data collection requirement when the UE performs inference on an AI unit, and the third information includes a third identifier and a fourth identifier.

The third identifier and the fourth identifier are used to indicate different data mapping manners, for example, respectively indicate a third data mapping manner and a fourth data mapping manner.

It should be noted that if the UE and the base station have exchanged the third identifier and the fourth identifier in the model identification exchange phase, step 2-3.1 may not be needed.

Step 2-3.2: The base station maps a horizontal direction (or a physical identifier in a horizontal direction) through the third data mapping manner to obtain a horizontal virtual identifier associated with the measurement resource, and maps a vertical direction (or a physical identifier in a vertical direction) through the fourth data mapping manner to obtain a vertical virtual identifier associated with the measurement resource.

Step 2-3.3: The base station sends first information to the UE, where the first information includes the third identifier, the fourth identifier, the horizontal virtual identifier associated with a measurement resource, and the vertical virtual identifier associated with the measurement resource.

Step 2-3.4: The UE generates, according to the horizontal virtual identifier and the vertical virtual identifier, a data set (as an input for generating the AI unit) used for inference by the AI unit.

The UE uses the horizontal virtual identifier associated with the measurement resource, the vertical virtual identifier associated with the measurement resource, and the measurement result associated with the measurement resource as the input for inference by the AI unit.

Implementation 3-1: The data collection during monitoring of an AI unit, as shown in FIG. 10, includes step 3-1.1 to step 3-1.5 below.

Step 3-1.1: A UE sends third information to a base station, where the third information is used to indicate a data collection requirement when the UE monitors an AI unit, and the third information includes a first identifier and first indication information. Herein, the third information may also be referred to as a monitoring request.

Herein, the first identifier is used to indicate a first data mapping manner, and the first indication information is used to indicate that a horizontal direction (or a physical identifier in a horizontal direction) and a vertical direction (or a physical identifier in a vertical direction) of a transmit beam of the base station are respectively mapped to a horizontal virtual identifier and a vertical virtual identifier through the first data mapping manner.

It should be noted that if the UE has reported the first identifier and the first indication information to a network in the model identification exchange phase, the monitoring request may not include the first identifier and the first indication information.

Step 3-1.2: The base station maps the horizontal direction (or the physical identifier in the horizontal direction) through the first data mapping manner according to the first indication information, to obtain a horizontal virtual identifier associated with the measurement resource, and maps the vertical direction (or the physical identifier in the vertical direction) through the first data mapping manner, to obtain a vertical virtual identifier associated with the measurement resource.

Step 3-1.3: The base station sends first information to the UE, where the first information includes a first identifier, a horizontal virtual identifier associated with a measurement resource, and a vertical virtual identifier associated with the measurement resource.

Step 3-1.4: The UE receives the first information send by the base station.

Step 3-1.5: The UE collects monitoring data. For example, the UE obtains a measurement result by performing inference on a measurement resource according to the horizontal virtual identifier and the vertical virtual identifier, generates an input data set used for inference by an AI unit, and then obtains an output of the AI unit after inference by the AI unit.

The UE uses the horizontal virtual identifier associated with the measurement resource, the vertical virtual identifier associated with the measurement resource, and the measurement result associated with a monitoring measurement resource as the input of the AI unit. A monitoring data set is generated according to the output of the AI unit and the tag data.

Implementation 3-2: The data collection during monitoring of the AI unit, as shown in FIG. 11, includes step 1-2.1 to step 1-2.5 below.

Step 3-2.1: A UE sends third information to a base station, where the third information is used to indicate a data collection requirement when the UE monitors an AI unit, and the third information includes a second identifier and second indication information. Herein, the third information may also be referred to as a monitoring request.

It should be noted that if the UE has reported the second identifier and the second indication information to a network in the model identification exchange phase, the monitoring request may not include the second identifier and the second indication information.

Herein, the second identifier is used to indicate a second data mapping manner, and the second indication information is used to indicate that the horizontal direction (or a physical identifier in a horizontal direction) and the vertical direction (or a physical identifier in a vertical direction) of the transmit beam of the base station are respectively mapped to a horizontal virtual identifier and a vertical virtual identifier through the second data mapping manner, and then two-dimensional data formed by the horizontal virtual identifier and the vertical virtual identifier is mapped to a one-dimensional target identifier.

Step 3-2.2: The base station respectively maps, to the horizontal virtual identifier and the vertical virtual identifier through the second data mapping manner according to the second indication information, the horizontal direction (or the physical identifier in the horizontal direction) and the vertical direction (or the physical identifier in the vertical direction) of the transmit beam of the base station, and then maps the two-dimensional data formed by the horizontal virtual identifier and the vertical virtual identifier to the one-dimensional target virtual identifier.

Step 3-2.3: The base station sends first information to the UE, where the first information includes a second identifier, a target virtual identifier, and second information.

A mapping relationship exists between the target virtual identifier and the horizontal virtual identifier and the vertical virtual identifier. The second information is used to indicate the mapping relationship. Therefore, the second information is used to indicate splitting the one-dimensional data of the target virtual identifier into two-dimensional data formed by the horizontal virtual identifier and the vertical virtual identifier, so that the second information may also be referred to as a two-dimensional splitting indication.

In addition, the second information is used to indicate a reference parameter, a quantity of values of the reference parameter, and a functional relationship between the target virtual identifier and the horizontal virtual identifier and the vertical virtual identifier. The reference parameter is one of the horizontal direction and the vertical direction. For example, when the reference parameter is the horizontal direction, the quantity of values of the reference parameter is a quantity of the horizontal direction. When the reference parameter is the vertical direction, the quantity of values of the reference parameter is a quantity of the vertical direction.

Step 3-2.4: The UE determines the horizontal virtual identifier and the vertical virtual identifier according to the target virtual identifier and the second information.

Step 3-2.5: The UE collects monitoring data. For example, the UE obtains a measurement result by performing inference on a measurement resource according to the horizontal virtual identifier and the vertical virtual identifier, generates an input data set used for performing inference by an AI unit, and then obtains an output of the AI unit after inference by the AI unit.

The UE uses the horizontal virtual identifier associated with the measurement resource, the vertical virtual identifier associated with the measurement resource, and the measurement result associated with a monitoring measurement resource as the input of the AI unit. A monitoring data set is generated according to the output of the AI unit and the tag data.

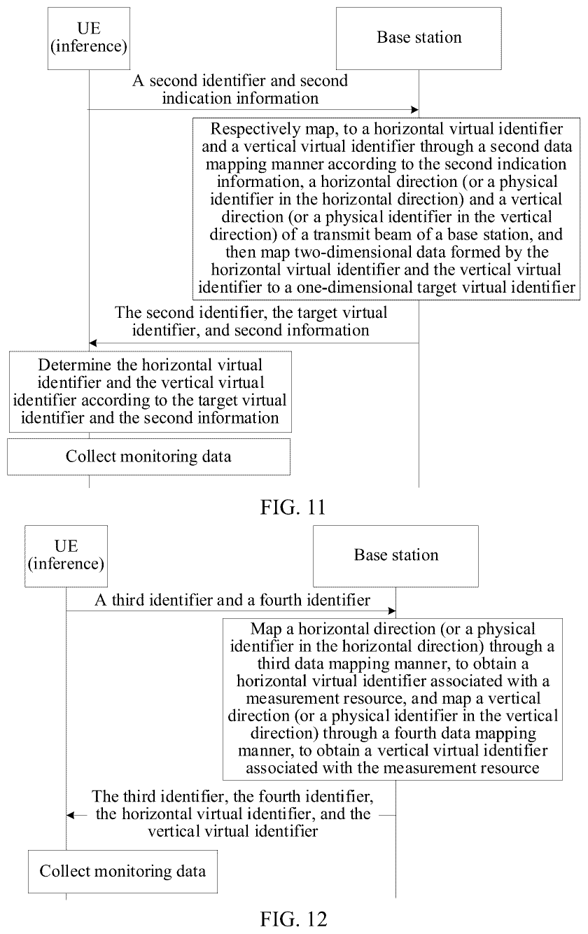

Implementation 3-3: The data collection during monitoring of an AI unit, as shown in FIG. 12, includes step 3-3.1 to step 3-3.4 below.

Step 3-3.1: A UE sends third information to a base station, where the third information is used to indicate a data collection requirement when the UE monitors an AI unit, and the third information includes a third identifier, a fourth identifier, and first indication information. Herein, the third information may also be referred to as a monitoring request.

The third identifier and the fourth identifier are used to indicate different data mapping manners, for example, respectively indicate a third data mapping manner and a fourth data mapping manner. The first indication information is used to indicate that a horizontal direction (or a physical identifier in a horizontal direction) is mapped through the third data mapping manner to obtain a horizontal virtual identifier associated with the measurement resource, and that a vertical direction (or a physical identifier in a vertical direction) is mapped through the fourth data mapping manner to obtain a vertical virtual identifier associated with the measurement resource.

It should be noted that if the UE has reported the third identifier, the fourth identifier, and the first indication information to a network in the model identification exchange phase, the monitoring request may not include the third identifier, the fourth identifier, and the first indication information.

In addition, the foregoing third information may alternatively not include the first indication information. In this way, after receiving the third identifier and the fourth identifier, the base station maps the horizontal direction (or the physical identifier in a horizontal direction) through the third data mapping manner by default to obtain the horizontal virtual identifier associated with the measurement resource, and maps the vertical direction (or the physical identifier in the vertical direction) through the fourth data mapping manner to obtain the vertical virtual identifier associated with the measurement resource.

Step 3-3.2: The base station maps the horizontal direction (or the physical identifier in a horizontal direction) through the third data mapping manner to obtain the horizontal virtual identifier associated with the measurement resource, and maps the vertical direction (or the physical identifier in the vertical direction) through the fourth data mapping manner to obtain the vertical virtual identifier associated with the measurement resource.

Step 3-3.3: The base station sends first information to the UE, where the first information includes the third identifier, the fourth identifier, the horizontal virtual identifier associated with a measurement resource, and the vertical virtual identifier associated with the measurement resource.

Step 3-3.4: The UE collects monitoring data. For example, the UE collects monitoring data. Specifically, the UE obtains a measurement result by performing inference on a measurement resource according to the horizontal virtual identifier and the vertical virtual identifier, generates an input data set used for inference by an AI unit, and then obtains an output of the AI unit after inference by the AI unit.

The UE uses the horizontal virtual identifier associated with the measurement resource, the vertical virtual identifier associated with the measurement resource, and the measurement result associated with a monitoring measurement resource as the input of the AI unit. A monitoring data set is generated according to the output of the AI unit and the tag data.

It should be noted that, in the foregoing implementations 3-1 to 3-3, after collecting the monitoring data (for example, the output and the tag data of the AI unit) of the AI unit, the UE may report the monitoring data to the base station, so that the base station may compare the output of the AI unit with the tag data, to control, according to a comparison result, whether the AI unit is turned off, and determine whether the AI unit needs to be trained again. Alternatively, the UE determines, according to a monitoring and reporting event preconfigured by the base station and according to the monitoring data, whether the monitoring and reporting event is satisfied, and reports a corresponding monitoring event.

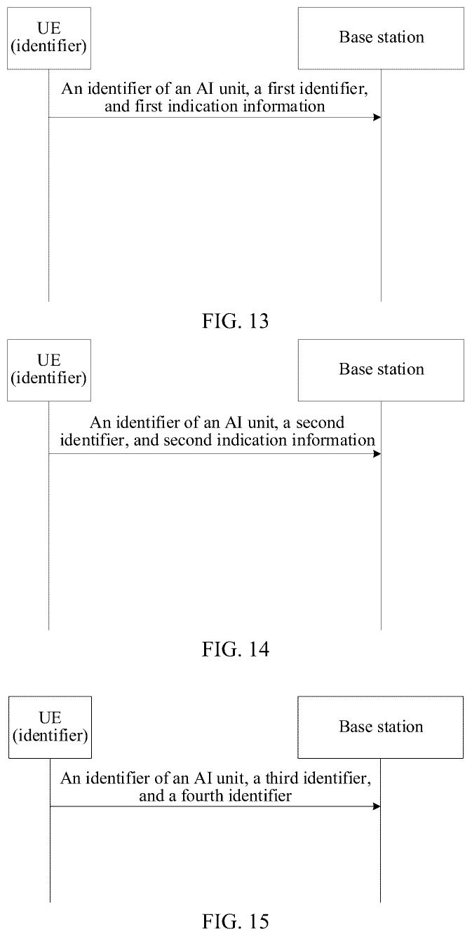

Implementation 4-1: An exchange phase of an AI unit identifier or a functionality identifier, as shown in FIG. 13, includes step 4-1.1 below.

Step 4-1.1: A UE sends third information to a base station, where the third information is used to indicate a data collection requirement when the UE performs inference on the AI unit or monitors the AI unit, and the third information includes a first identifier and first indication information. Optionally, the third information herein may further include an identifier of the AI unit or an identifier of the AI functionality.

Herein, the first identifier is used to indicate a first data mapping manner, and the first indication information is used to indicate that a horizontal direction (or a physical identifier in a horizontal direction) and a vertical direction (or a physical identifier in a vertical direction) of a transmit beam of the base station are respectively mapped to a horizontal virtual identifier and a vertical virtual identifier through the first data mapping manner.

Optionally, the following step may be further included.

Step 4-1.2: In a phase of UE capability reporting or functionality indication, the terminal may instruct, through UE capability signaling, support configuration of a one-dimensional identifier or configuration of a two-dimensional identifier.

The configuration of the two-dimensional identifier means that the horizontal direction (or the physical identifier in the horizontal direction) and the vertical direction (or the physical identifier in the vertical direction) of the transmit beam of the base station are respectively mapped to the horizontal virtual identifier and the vertical virtual identifier.

The configuration of a two-dimensional identifier means that the horizontal direction (or the physical identifier in the horizontal direction) and the vertical direction (or the physical identifier in the vertical direction) of the transmit beam of the base station are respectively mapped to the horizontal virtual identifier and the vertical virtual identifier, and then the two-dimensional data formed by the horizontal virtual identifier and the vertical virtual identifier is mapped to the one-dimensional target virtual identifier.

Implementation 4-2: An exchange phase of an AI unit identifier or a functionality identifier, as shown in FIG. 14, includes step 4-2.1 below.

Step 4-2.1: A UE sends third information to a base station, where the third information is used to indicate a data collection requirement when the UE performs inference on the AI unit or monitors the AI unit, and the third information includes a second identifier and second indication information. Optionally, the third information herein may further include an identifier of the AI unit or an identifier of the AI functionality.

Herein, the second identifier is used to indicate a second data mapping manner, and the second indication information is used to indicate that the horizontal direction (or a physical identifier in a horizontal direction) and the vertical direction (or a physical identifier in a vertical direction) of the transmit beam of the base station are respectively mapped to a horizontal virtual identifier and a vertical virtual identifier through the second data mapping manner, and then two-dimensional data formed by the horizontal virtual identifier and the vertical virtual identifier is mapped to a one-dimensional target virtual identifier.

Optionally, the following step may be further included.

Step 4-2.2: In a phase of UE capability reporting or functionality indication, the terminal may instruct, through UE capability signaling, support configuration of a one-dimensional identifier or configuration of a two-dimensional identifier.

The configuration of the two-dimensional identifier means that the horizontal direction (or the physical identifier in the horizontal direction) and the vertical direction (or the physical identifier in the vertical direction) of the transmit beam of the base station are respectively mapped to the horizontal virtual identifier and the vertical virtual identifier.

The configuration of a two-dimensional identifier means that the horizontal direction (or the physical identifier in the horizontal direction) and the vertical direction (or the physical identifier in the vertical direction) of the transmit beam of the base station are respectively mapped to the horizontal virtual identifier and the vertical virtual identifier, and then the two-dimensional data formed by the horizontal virtual identifier and the vertical virtual identifier is mapped to the one-dimensional target virtual identifier.

Implementation 4-3: An exchange phase of an AI unit identifier or a functionality identifier, as shown in FIG. 15, includes step 4-3.1 below.

Step 4-3.1: A UE sends third information to a base station, where the third information is used to indicate a data collection requirement when the UE performs inference on the AI unit or monitoring the AI unit, and the third information includes a third identifier, a fourth identifier, and first indication information. Optionally, the third information herein may further include an identifier of the AI unit or an identifier of the AI functionality.

Herein, the third identifier and the fourth identifier are used to indicate different data mapping manners, for example, respectively indicate a third data mapping manner and a fourth data mapping manner. The first indication information is used to indicate that a horizontal direction (or a physical identifier in a horizontal direction) is mapped through the third data mapping manner to obtain a horizontal virtual identifier associated with the measurement resource, and that a vertical direction (or a physical identifier in a vertical direction) is mapped through the fourth data mapping manner to obtain a vertical virtual identifier associated with the measurement resource.

It may be understood that the foregoing third information may alternatively not include the first indication information. In this way, after receiving the third identifier and the fourth identifier, the base station maps the horizontal direction (or the physical identifier in a horizontal direction) through the third data mapping manner by default to obtain the horizontal virtual identifier associated with the measurement resource, and maps the vertical direction (or the physical identifier in the vertical direction) through the fourth data mapping manner to obtain the vertical virtual identifier associated with the measurement resource.

Optionally, the following step may be further included.

Step 4-3.2: In a phase of UE capability reporting or functionality indication, the terminal may indicate, via UE capability signaling, its supported configuration of a one-dimensional identifier or a two-dimensional identifier.

The configuration of the two-dimensional identifier means that the horizontal direction (or the physical identifier in the horizontal direction) and the vertical direction (or the physical identifier in the vertical direction) of the transmit beam of the base station are respectively mapped to the horizontal virtual identifier and the vertical virtual identifier.

The configuration of a two-dimensional identifier means that the horizontal direction (or the physical identifier in the horizontal direction) and the vertical direction (or the physical identifier in the vertical direction) of the transmit beam of the base station are respectively mapped to the horizontal virtual identifier and the vertical virtual identifier, and then the two-dimensional data formed by the horizontal virtual identifier and the vertical virtual identifier is mapped to the one-dimensional target virtual identifier.

According to the above, in this embodiment of this application, privacy processing is respectively performed on two dimensions of the transmit beam, namely, the horizontal dimension and the vertical dimension, which helps reserve a relative relationship between some beams and the UE to extract a feature of the transmit beam, thereby improving accuracy of beam prediction. In addition, it is ensured that the sensitive information of the beam is not exposed.

In an example, Table 7 shows original beam physical identifiers. Privacy (for example, a one-dimensional hybrid privacy method) is performed on the beam physical identifiers shown in Table 7 by mixing the horizontal dimension and the vertical dimension in the prior art, to obtain virtual identifiers shown in Table 8. Privacy is performed the beam physical identifiers shown in Table 7 through the foregoing method (such as Implementation 2 above or a two-dimensional respective privacy method) in this embodiment of this application, to obtain virtual identifiers shown in Table 9.

TABLE 7
Original beam physical identifiers

Horizontal

| Vertical | 1 | 2 | 3 | 4 | 5 | 6 | 7 | 8 |
|---|---|---|---|---|---|---|---|---|
| 1 | 1 | 5 | 9 | 13 | 17 | 21 | 25 | 29 |
| 2 | 2 | 6 | 10 | 14 | 18 | 22 | 26 | 30 |
| 2 | 3 | 7 | 11 | 15 | 19 | 23 | 27 | 31 |
| 4 | 4 | 8 | 12 | 16 | 20 | 24 | 28 | 32 |

TABLE 8
Virtual identifiers after one-dimensional hybrid privacy

Horizontal

| Vertical | 1 | 2 | 3 | 4 | 5 | 6 | 7 | 8 |
|---|---|---|---|---|---|---|---|---|
| 1 | 23 | 1 | 26 | 8 | 22 | 32 | 6 | 15 |
| 2 | 17 | 4 | 20 | 7 | 14 | 28 | 9 | 5 |
| 2 | 29 | 25 | 12 | 11 | 27 | 13 | 24 | 30 |
| 4 | 3 | 19 | 16 | 21 | 31 | 2 | 10 | 18 |

TABLE 9
Virtual identifiers after two-dimensional respective privacy method

Horizontal

| Vertical | 1 | 2 | 3 | 4 | 5 | 6 | 7 | 8 |
|---|---|---|---|---|---|---|---|---|
| 1 | 22 | 3 | 18 | 10 | 26 | 6 | 30 | 14 |
| 2 | 23 | 2 | 19 | 11 | 27 | 7 | 31 | 15 |
| 2 | 24 | 4 | 20 | 12 | 28 | 8 | 32 | 16 |
| 4 | 21 | 1 | 17 | 9 | 25 | 5 | 29 | 13 |

When the beam physical identifiers shown in Table 7 are processed through the one-dimensional hybrid de-privacy method (for example, through a random disruption method), 8*4=32 correspondences between the horizontal direction, the vertical direction, and the identifiers need to be changed. When the beam physical identifiers shown in Table 7 are processed through the two-dimensional respective de-privacy method, only 8 correspondences between horizontal direction and identifiers and 4 correspondences between vertical direction and identifiers need to be respectively disrupted, and a total of 8+4=12 correspondences are changed. It can be seen that, in the two-dimensional respective de-privacy method herein, only 12 correspondences are changed instead of 32 relationships. In this way, relative relationships between some beams are reserved. For example, in Table 9, differences between values in two adjacent rows or two columns are equal, and in Table 8, the relationship does not exist. Therefore, de-privacy processing is respectively performed on two dimensions of the transmit beam, namely, the horizontal dimension and the vertical dimension, helping to reserve a relative relationship between some beams.

The data collection method provided in this embodiment of this application may be performed by a data collection apparatus. In this embodiment of this application, the data collection apparatus provided in this embodiment of this application is described by using an example in which the data collection apparatus performs the data collection method.

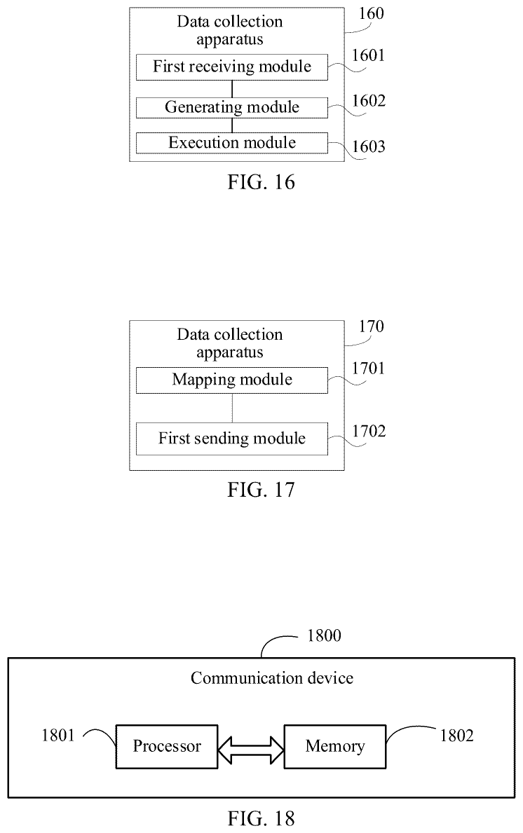

According to a third aspect, an embodiment of this application provides a data collection apparatus. The data collection apparatus may be applied to a first device. As shown in FIG. 16, the data collection apparatus 160 includes the following modules:
a first receiving module 1601, configured to receive first information sent by a second device, where the first information includes target identifiers and a plurality of pieces of target information, the plurality of pieces of target information are used to indicate N items of mapping data, which correspond to N parameters of sensitive information of the second device, the plurality of pieces of target information are obtained by performing data mapping on the N parameters according to target data mapping manners, and the target identifiers are used to indicate the target data mapping manners;
a generating module 1602, configured to generate a data set according to the plurality of pieces of target information; and
an execution module 1603, configured to perform, according to the target identifiers and the data set, at least one of the following:
training an artificial intelligence AI unit, where at least one of the AI unit and the data set is associated with the target identifiers;
performing inference on the AI unit; or
monitoring the AI unit.

Optionally, the plurality of pieces of target information include the N items of mapping data, the target data mapping manners include N first data mapping manners, i^{th} mapping data is obtained by performing processing on an i^{th} parameter of the sensitive information according to an i^{th} first data mapping manner, and i is an integer ranging from 1 to N.

Optionally, the target information includes first data and second information, and the second information is used to indicate a mapping relationship between the first data and the N items of mapping data. The generating module 1602 is specifically configured to:
determine the N items of mapping data according to the mapping relationships indicated by the second information and the first data; and
generate the data set according to the N items of mapping data.

Optionally, the second information includes a reference parameter, a quantity of values of the reference parameter, and a functional relationship between the first data and the N items of mapping data; and
the reference parameter is at least some of the N parameters.

Optionally, the apparatus further includes:
a second sending module, configured to send third information to the second device, where
the third information includes the target identifiers and a plurality of pieces of target indication information, and the plurality of pieces of target indication information are used to indicate that data mapping is respectively performed on the N parameters.

Optionally, when the target data mapping manners include the N first data mapping manners, the plurality of pieces of target indication information includes a plurality of pieces of first indication information, the plurality of pieces of first indication information are used to indicate that the N parameters are respectively mapped to the N items of mapping data through the N first data mapping manners.

When the target data mapping manner includes a second data mapping manner, the target indication information includes second indication information, and the second indication information is used to indicate that the N parameters are respectively mapped to the N items of mapping data through the second data mapping manner, and then N-dimensional data formed by the N items of mapping data is mapped to one-dimensional data.

Optionally, the apparatus further includes:
a fourth sending module, configured to send capability information to the second device when the first device is a terminal device, where the capability information is used to indicate that the terminal device supports first processing manners or second processing manners;
the first processing manners are manners of mapping the N parameters to the N items of mapping data; and
the second processing manners ae manners of mapping the N parameters to the N items of mapping data, and then mapping the N items of mapping data to the one-dimensional data.

Optionally, the sensitive information includes a transmit beam direction, and the N parameters include N direction dimensions of the transmit beam directions.

The data collection apparatus in embodiments of this application may be an electronic device, for example, an electronic device having an operating system, or a component in an electronic device, such as an integrated circuit or a chip. This electronic device may be a terminal. In an example, the terminal may include but is not limited to the foregoing listed types of the terminal 11, which is not specifically limited in embodiments of this application.

The data collection apparatus provided in embodiments of this application can implement the processes implemented in the method embodiment of FIG. 2, and achieve a same technical effect. To avoid repetition, details are not described herein again.

According to a fourth aspect, an embodiment of this application provides a data collection apparatus. The data collection apparatus may be applied to a second device. As shown in FIG. 17, the data collection apparatus 170 includes the following modules:
a mapping module 1701, configured to perform data mapping on N parameters of sensitive information of the second device according to a target data mapping manner, to obtain target information, where the target information is used to indicate N items of mapping data corresponding to the N parameters; and
a first sending module 1702, configured to send first information to a first device, where the first information includes the plurality of pieces of target information and target identifiers, the target identifiers are used to indicate the target data mapping manners, and the N items of mapping data are used to generate a data set.

The data set is used to perform at least one of the following:
training an artificial intelligence AI unit, where at least one of the AI unit and the data set is associated with the target identifiers;
performing inference on the AI unit; or
monitoring the AI unit.

Optionally, the target data mapping manner includes N first data mapping manners.

The mapping module 1701 is specifically configured to:
perform data mapping on an i^{th} parameter among the N parameters through an i^{th} first data mapping manner, to obtain i^{th} mapping data, where i is an integer ranging from 1 to N; and
determine the obtained N items of mapping data as the target information.

Optionally, the target data mapping manner includes a second data mapping manner.

The mapping module 1701 is specifically configured to:
respectively perform data mapping on the N parameters through the second data mapping manner, to obtain the N items of mapping data;
map N-dimensional data formed by the N items of mapping data to one-dimensional data, to obtain first data; and
determine the first data and second information as the plurality of pieces of target information, where
the second information is used to indicate mapping relationships between the first data and the N items of mapping data.

Optionally, the second information includes a reference parameter, a quantity of values of the reference parameter, and a functional relationship between the first data and the N items of mapping data; and
the reference parameter is at least some of the N parameters.

Optionally, the apparatus further includes:
a second receiving module, configured to receive third information sent by the first device, where the third information includes the target identifier and target indication information, and the target indication information is used to indicate that data mapping is respectively performed on the N parameter.

The mapping module 1701 is specifically configured to:
perform, according to the plurality of pieces of target indication information, data mapping on the N parameters through the target data mapping manners indicated by the target identifiers, to obtain the plurality of pieces of target information.

Optionally, when the target data mapping manners include the N first data mapping manners, the plurality of pieces of target indication information include a plurality of pieces of first indication information, the plurality of pieces of first indication information are used to indicate that the N parameters are respectively mapped to the N items of mapping data through the N first data mapping manners.

When the target data mapping manners include second data mapping manners, the plurality of pieces of target indication information include second indication information, and the second indication information is used to indicate that the N parameters are respectively mapped to the N items of mapping data through the second data mapping manner, and then N-dimensional data formed by the N items of mapping data is mapped to one-dimensional data.

Optionally, the apparatus further includes:
a third receiving module, configured to receive capability information sent by the first device when the first device is a terminal device, where
the capability information is used to indicate that the terminal device supports first processing manners or second processing manners;
the first processing manners are manners of mapping the N parameters to the N items of mapping data, and then mapping the N items of mapping data to the one-dimensional data; and
the second processing manners are manners of mapping the N parameters to the N items of mapping data.

Optionally, the sensitive information includes a transmit beam direction, and the N parameters include N direction dimensions of the transmit beam directions.

The data collection apparatus in embodiments of this application may be an electronic device, for example, an electronic device having an operating system, or a component in an electronic device, such as an integrated circuit or a chip. The electronic device may be a network side device. For example, the network side device may include but not limited to the type of the network side device 12 listed above. This is not specifically limited in embodiments of this application.

The data collection apparatus provided in embodiments of this application can implement the processes implemented in the method embodiment of FIG. 3, and achieve a same technical effect. To avoid repetition, details are not described herein again.

As shown in FIG. 18, an embodiment of this application further provides a communication device 1800, including a processor 1801 and a memory 1802. The memory 1802 stores a program or an instruction executable in the processor 1801. For example, when the communication device 1800 is a first device, the program or the instruction, when executed by the processor 1801, implements the steps of embodiments of the data collection method in the foregoing first aspect, and can achieve the same technical effect. When the communication device 1800 is a second device, the program or the instruction, when executed by the processor 1801, implements each step of the data collection method embodiment in the foregoing second aspect, and can achieve the same technical effect. To avoid repetition, details are not described herein again.

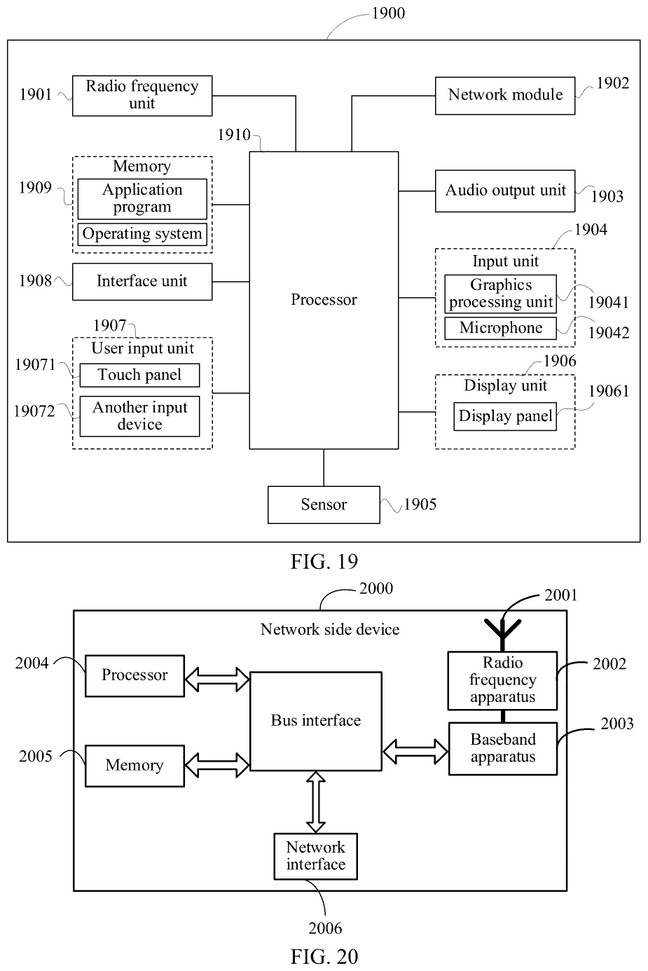

An embodiment of this application further provides a terminal, including a processor and a communication interface. The communication interface is coupled to the processor, and the processor is configured to run a program or an instruction, to implement the steps of the method embodiment shown in FIG. 2. The terminal embodiment corresponds to the foregoing method embodiment of the terminal side. The implementation processes and implementations of the foregoing method embodiment are all applicable to the terminal embodiment, and can achieve the same technical effects. Specifically, FIG. 19 is a schematic diagram of a hardware structure of a terminal for implementing an embodiment of this application.

The terminal 1900 includes, but is not limited to, at least some components such as a radio frequency unit 1901, a network module 1902, an audio output unit 1903, an input unit 1904, a sensor 1905, a display unit 1906, a user input unit 1907, an interface unit 1908, a memory 1909, and a processor 1910.

A person skilled in the art may understand that the terminal 1900 may further include a power supply (for example, a battery) that supplies power to the components. The power supply may be logically connected to the processor 1910 through a power management system, to implement functionalities such as management of charging, discharging, and power consumption through the power management system. The terminal structure shown in FIG. 19 constitutes no limitation on the terminal, and the terminal may include more or fewer components than those shown in the figure, or some merged components, or different component arrangements. Details are not described herein again.

It should be noted that, in this embodiment of this application, the input unit 1904 may include a graphics processing unit (Graphics Processing Unit, GPU) 19041 and a microphone 19042. The graphics processing unit 19041 processes image data of a static picture or a video obtained by an image capturing apparatus (for example, a camera) in a video capturing mode or an image capturing mode. The display unit 1906 may include a display panel 19061. The display panel 19061 may be configured in a form such as a liquid crystal display or an organic light-emitting diode. The user input unit 1907 includes at least one of a touch panel 19071 or another input device 19072. The touch panel 19071 is also referred to as a touchscreen. The touch panel 19071 may include two parts: a touch detection apparatus and a touch controller. The another input device 19072 may include but is not limited to a physical keyboard, a function button (for example, a volume control button or a power button), a trackball, a mouse, and a joystick. Details are not described herein again.

In this embodiment of this application, the radio frequency unit 1901 receives downlink data from a network side device and may provide the downlink data to the processor 1910 for processing. In addition, the radio frequency unit 1901 may send uplink data to the network side device. Generally, the radio frequency unit 1901 includes, but is not limited to, an antenna, an amplifier, a transceiver, a coupler, a low noise amplifier, a duplexer, and the like.

The memory 1909 may be configured to store a software program or an instruction and various data. The memory 1909 may include mainly a first storage area for storing a program or instructions and a second storage area for storing data. The first storage area may store an operating system, an application program or an instruction required for at least one function (for example, a sound playback function and a picture playback function), and the like. In addition, the memory 1909 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1909 in embodiments of this application includes, but is not limited to these memories and any other memories of suitable types.

The processor 1910 may include one or more processing units. Optionally, the processor 1910 integrates an application processor and a modem processor. The application processor mainly processes operations related to an operating system, a user interface, an application program, and the like. The modem processor mainly processes wireless communication signals, and is, for example, a baseband processor. It may be understood that the foregoing modem processor may alternatively not be integrated into the processor 1910.

The radio frequency unit 1901 is configured to receive first information sent by a second device, where the first information includes target identifiers and a plurality of pieces of target information, the plurality of pieces of target information are used to indicate N items of mapping data, which correspond to N parameters of sensitive information of the second device, the plurality of pieces of target information are obtained by performing data mapping on the N parameters according to target data mapping manners, and the target identifiers are used to indicate the target data mapping manners.

The processor 1910 is configured to generate a data set according to the plurality of pieces of target information.

According to the target identifiers and the data set, at least one of the following is performed:
training an artificial intelligence AI unit, where at least one of the AI unit and the data set is associated with the target identifiers;
performing inference on the AI unit; or
monitoring the AI unit.

Optionally, the plurality of pieces of target information include the N items of mapping data, the target data mapping manners include N first data mapping manners, i^{th} mapping data is obtained by performing processing on an i^{th} parameter of the sensitive information according to an i^{th} first data mapping manner, and i is an integer ranging from 1 to N.

Optionally, the target information includes first data and second information, and the second information is used to indicate a mapping relationship between the first data and the N items of mapping data. That the processor 1910 generates a data set according to the plurality of pieces of target information includes:
determining the N items of mapping data according to the mapping relationships indicated by the second information and the first data; and
generating the data set according to the N items of mapping data.

Optionally, the second information includes a reference parameter, a quantity of values of the reference parameter, and a functional relationship between the first data and the N items of mapping data; and
the reference parameter is at least some of the N parameters.

Optionally, before the radio frequency unit 1901 receives first information sent by a second device, the method is further configured to:
send third information to the second device, where
the third information includes the target identifiers and a plurality of pieces of target indication information, and the plurality of pieces of target indication information are used to indicate that data mapping is respectively performed on the N parameters.

Optionally, when the target data mapping manners include the N first data mapping manners, the plurality of pieces of target indication information include a plurality of pieces of first indication information, the plurality of pieces of first indication information are used to indicate that the N parameters are respectively mapped to the N items of mapping data through the N first data mapping manners.

When the target data mapping manners include second data mapping manners, the plurality of pieces of target indication information include second indication information, and the second indication information is used to indicate that the N parameters are respectively mapped to the N items of mapping data through the second data mapping manners, and then N-dimensional data formed by the N items of mapping data is mapped to one-dimensional data.

Optionally, the radio frequency unit 1901 is further configured to:
send capability information to the second device when the first device is a terminal device, where the capability information is used to indicate that the terminal device supports first processing manners or second processing manners;
the first processing manners are manners of mapping the N parameters to the N items of mapping data; and
the second processing manners are manners of mapping the N parameters to the N items of mapping data, and then mapping the N items of mapping data to the one-dimensional data.

Optionally, the sensitive information includes a transmit beam direction, and the N parameters include N direction dimensions of the transmit beam directions.

It may be understood that the implementation process of each implementation in this embodiment may refer to the relevant description of the data collection method embodiments, and the same or corresponding technical effect is achieved. To avoid repetition, details are not described herein again.

An embodiment of this application further provides a network side device, including a processor and a communication interface. The communication interface is coupled to the processor. The processor is configured to run a program or an instruction, to implement the steps of the method embodiment shown in FIG. 3. An embodiment of the network side device corresponds to the foregoing method embodiment of the network side device. Each implementation process and implementation of the foregoing method embodiment can be applied to this embodiment of the network side device, and can achieve the same technical effect.

Specifically, an embodiment of this application further provides a network side device. As shown in FIG. 20, the network side device 2000 includes an antenna 2001, a radio frequency apparatus 2002, a baseband apparatus 2003, a processor 2004, and a memory 2005. The antenna 2001 is connected to the radio frequency apparatus 2002. In an uplink direction, the radio frequency apparatus 2002 receives information through the antenna 2001, and sends the received information to the baseband apparatus 2003 for processing. In a downlink direction, the baseband apparatus 2003 processes to-be-sent information, and sends the processed to-be-sent information to the radio frequency apparatus 2002. The radio frequency apparatus 2002 processes the received information, and then sends the processed information through the antenna 2001.

The method performed by the network side device in the foregoing embodiment may be implemented by the baseband apparatus 2003. The baseband apparatus 2003 includes a baseband processor.

The baseband apparatus 2003 may include, for example, at least one baseband board. A plurality of chips are arranged on the baseband board, as shown in FIG. 20. One of the chips is, for example, a baseband processor, and is connected to the memory 2005 through a bus interface to call a program in the memory 2005, to perform the operations of the network device shown in the foregoing method embodiment.

The network side device may further include a network interface 2006. The interface is, for example, a common public radio interface (Common Public Radio Interface, CPRI).

Specifically, the network side device 2000 in this embodiment of this application further includes an instruction or a program stored in the memory 2005 and executable on the processor 2004. The processor 2004 invokes the instruction or the program in the memory 2005 to perform the method performed by each module shown in FIG. 17, and achieves the same technical effect. To avoid repetition, details are not described herein again.

An embodiment of this application further provides a readable storage medium. The readable storage medium stores a program or an instruction. The program or the instruction, when executed by a processor, implements the processes of the foregoing embodiments of the data collection method, and can achieve the same technical effect. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disk. In some examples, the readable storage medium may be a non-transitory readable storage medium.

An embodiment of this application further provides a chip. The chip includes a processor and a communication interface. The communication interface is coupled to the processor. The processor is configured to run a program or an instruction, to implement the processes of the foregoing embodiments of the data collection method, and can achieve the same technical effect. To avoid repetition, details are not described herein again.

It should be understood that the chip in this embodiment of this application may also be referred to as a system level chip, a system chip, a chip system, a system on chip, or the like.

An embodiment of this application further provides a computer program/program product. The computer program/program product is stored in a storage medium. The computer program/program product is executed by at least one processor to implement the processes of the foregoing embodiments of the data collection method, and can achieve the same technical effect. To avoid repetition, details are not described herein again.

An embodiment of this application further provides a communication system, including a first device and a second device. The first device may be configured to perform the steps of the method in the first aspect. The second device may be configured to perform the steps of the method in the second aspect.

It should be noted that in this specification, terms “include”, “including” or any other variants herein are intended to encompass non-exclusive inclusion, so that a process, a method, an article, or an apparatus including a series of elements not only include those elements, but also includes another element not listed explicitly or includes intrinsic elements for the process, the method, the article, or the apparatus. Without any further limitation, an element defined by a phrase “include one . . . ” does not exclude existence of an additional same element in the process, the method, the article, or the apparatus that includes the element. In addition, it should be noted that the scope of the method and the apparatus in the implementations of this application is not limited to function execution in the order shown or discussed, and may further include function execution in a substantially simultaneous manner or in a reverse order according to the involved functions. For example, the described method may be performed in an order different from the described order, and various steps may also be added, omitted, or combined. In addition, features described with reference to some examples may be combined in another example.

According to the descriptions of the foregoing implementations, a person skilled in the art may clearly learn that the method in the foregoing embodiments may be implemented by a computer software product with a necessary universal hardware platform, or may be implemented by hardware. The computer software product is stored in a storage medium (for example, a ROM, a RAM, a magnetic disk, or an optical disc) and includes several instructions, to enable the terminal or the network side device to perform the method in embodiments of this application.

Although embodiments of this application are described above with reference to the accompanying drawings, this application is not limited to the foregoing specific implementations. The foregoing specific implementations are illustrative only but not restrictive. With the enlightenment of this application, a person of ordinary skill in the art may make many forms of implementations without departing from the concept of this application and the protection scope of the claims. These implementations fall within the protection of this application.

What is claimed is:

1. A data collection method, comprising:
receiving, by a first device, first information sent by a second device, wherein the first information comprises target identifiers and a plurality of pieces of target information, the plurality of pieces of target information are used to indicate N items of mapping data, which correspond to N parameters of the sensitive information of the second device, the plurality of pieces of target information are obtained by performing data mapping on the N parameters according to target data mapping manners, and the target identifiers are used to indicate the target data mapping manners, where N is an integer greater than 1;
generating, by the first device, a data set according to the plurality of pieces of target information; and
performing, by the first device according to the target identifiers and the data set, at least one of the following:
training an artificial intelligence (AI) unit, wherein at least one of the AI unit and the data set is associated with the target identifiers;
performing inference on the AI unit; or
monitoring the AI unit.

2. The method according to claim 1, wherein the plurality of pieces of target information comprise the N items of mapping data, the target data mapping manners comprise N first data mapping manners, i^{th} mapping data is obtained by performing processing on an i^{th} parameter of the sensitive information according to an i^{th} first data mapping manner, and i is an integer ranging from 1 to N,
or
wherein the plurality of pieces of target information comprise first data and a plurality of pieces of second information, and the plurality of pieces of second information are used to indicate mapping relationships between the first data and the N items of mapping data; and
the generating, by the first device, a data set according to the plurality of pieces of target information comprises:
determining, by the first device, the N items of mapping data according to the mapping relationships indicated by the second information and the first data; and
generating, by the first device, the data set according to the N items of mapping data.

3. The method according to claim 2, wherein the second information comprises a reference parameter, a quantity of values of the reference parameter, and a functional relationship between the first data and the N items of mapping data; and
the reference parameter is at least some of the N parameters.

4. The method according to claim 1, wherein before the receiving, by a first device, first information sent by a second device, the method further comprises:
sending, by the first device, third information to the second device, wherein
the third information comprises the target identifiers and a plurality of pieces of target indication information, and the plurality of pieces of target indication information are used to indicate that data mapping is respectively performed on the N parameters.

5. The method according to claim 4, wherein when the target data mapping manners comprise the N first data mapping manners, the plurality of pieces of target indication information comprise a plurality of pieces of first indication information, the plurality of pieces of first indication information are used to indicate that the N parameters are respectively mapped to the N items of mapping data through the N first data mapping manners; and
when the target data mapping manner comprises a second data mapping manner, the target indication information comprises second indication information, and the second indication information is used to indicate that the N parameters are respectively mapped to the N items of mapping data through the second data mapping manner, and then N-dimensional data formed by the N items of mapping data is mapped to one-dimensional data.

6. The method according to claim 1, further comprising:
sending, by the first device, capability information to the second device when the first device is a terminal device, wherein the capability information is used to indicate that the terminal device supports first processing manners or second processing manners;
the first processing manners are manners of mapping the N parameters to the N items of mapping data; and
the second processing manners are manners of mapping the N parameters to the N items of mapping data, and then mapping the N items of mapping data to one-dimensional data.

7. The method according to claim 1, wherein the sensitive information comprises a transmit beam direction, and the N parameters comprise N direction dimensions of the transmit beam directions.

8. The method according to claim 1, wherein the sensitive information comprises beam information, and the beam information comprises at least one of: beam directions, beam shapes, or 3 dB beam widths.

9. The method according to claim 1, wherein an identifier of the AI unit is associated with the target identifiers.

10. The method according to claim 9, wherein the identifier of the AI unit comprises an identifier of an AI functionality.

11. The method according to claim 9, wherein the identifier of the AI unit comprises at least one of:
an identifier of an AI structure,
an identifier of an AI algorithm,
an identifier of an AI data set,
an identifier of an AI scenario,
an identifier of an AI environment,
an identifier of an AI channel feature,
an identifier of an AI device,
an identifier of an AI feature,
an identifier of an AI capability,
an identifier of an AI module,
an identifier of an AI model.

12. The method according to claim 1, wherein the AI unit comprises at least one of:
an AI structure,
an AI algorithm,
an AI data set,
an AI scenario,
an AI environment,
an AI channel feature,
an AI device,
an AI feature,
an AI capability,
an AI module,
an AI model,
an AI functionality.

13. A data collection method, comprising:
performing, by a second device, data mapping on N parameters of its plurality of pieces of sensitive information according to target data mapping manners, to obtain a plurality of pieces of target information, wherein the plurality of pieces of target information are used to indicate N items of mapping data corresponding to the N parameters, where N is an integer greater than 1; and
sending, by the second device, first information to a first device, wherein the first information comprises the plurality of pieces of target information and target identifiers, the target identifiers are used to indicate the target data mapping manners, and the N items of mapping data are used to generate a data set; and
the data set is used to perform at least one of the following:
training an artificial intelligence (AI) unit, wherein at least one of the AI unit and the data set is associated with the target identifiers;
performing inference on the AI unit; or
monitoring the AI unit.

14. The method according to claim 13, wherein the target data mapping manner comprises N first data mapping manners; and
the performing, by a second device, data mapping on N parameters of its plurality of pieces of sensitive information according to target data mapping manners, to obtain a plurality of pieces of target information comprises:
performing, by the second device, data mapping on an i^{th} parameter among the N parameters through an i^{th} first data mapping manner, to obtain i^{th} mapping data, wherein i is an integer ranging from 1 to N; and
determining, by the second device, the obtained N items of mapping data as the target information,
or
wherein the target data mapping manner comprises a second data mapping manner; and
the performing, by a second device, data mapping on N parameters of its plurality of pieces of sensitive information according to target data mapping manners, to obtain a plurality of pieces of target information comprises:
respectively performing, by the second device, data mapping on the N parameters through the second data mapping manner, to obtain the N items of mapping data;
mapping, by the second device, N-dimensional data formed by the N items of mapping data to one-dimensional data, to obtain first data; and
determining, by the second device, the first data and second information as the target information, wherein
the second information is used to indicate a mapping relationship between the first data and the N items of mapping data.

15. The method according to claim 14, wherein the second information comprises a reference parameter, a quantity of values of the reference parameter, and a functional relationship between the first data and the N items of mapping data; and
the reference parameter is at least some of the N parameters.

16. The method according to claim 13, wherein before the performing, by a second device, data mapping on N parameters of its plurality of pieces of sensitive information according to target data mapping manners, to obtain a plurality of pieces of target information, the method further comprises:
receiving, by the second device, third information sent by the first device, wherein the third information comprises the target identifiers and a plurality of pieces of target indication information, and the plurality of pieces of target indication information are used to indicate that data mapping is respectively performed on the N parameters; and
the performing, by a second device, data mapping on N parameters of its plurality of pieces of sensitive information according to target data mapping manners, to obtain a plurality of pieces of target information comprises:
performing, by the second device according to the plurality of pieces of target indication information, data mapping on the N parameters through the target data mapping manners indicated by the target identifiers, to obtain the plurality of pieces of target information.

17. The method according to claim 16, wherein when the target data mapping manners comprise the N first data mapping manners, the plurality of pieces of target indication information comprise a plurality of pieces of first indication information, the plurality of pieces of first indication information are used to indicate that the N parameters are respectively mapped to the N items of mapping data through the N first data mapping manners; and
when the target data mapping manners comprise second data mapping manners, the plurality of pieces of target indication information comprise a plurality of pieces of second indication information, and the plurality of pieces of second indication information are used to indicate that the N parameters are respectively mapped to the N items of mapping data through the second data mapping manners, and then N-dimensional data formed by the N items of mapping data is mapped to one-dimensional data.

18. The method according to claim 13, further comprising:
receiving, by the second device, capability information sent by the first device when the first device is a terminal device, wherein
the capability information is used to indicate that the terminal device supports first processing manners or second processing manners;
the first processing manners are manners of mapping the N parameters to the N items of mapping data; and
the second processing manners are manners of mapping the N parameters to the N items of mapping data, and then mapping the N items of mapping data to one-dimensional data.

19. A communication device, comprising a processor and a memory, wherein the memory stores a program or an instruction executable in the processor, and the program or the instruction, when executed by the processor, implements a data collection method, comprising:
receiving first information sent by a second device, wherein the first information comprises target identifiers and a plurality of pieces of target information, the plurality of pieces of target information are used to indicate N items of mapping data, which correspond to N parameters of sensitive information of the second device, the plurality of pieces of target information are obtained by performing data mapping on the N parameters according to target data mapping manners, and the target identifiers are used to indicate the target data mapping manners, where N is an integer greater than 1;
generating a data set according to the plurality of pieces of target information; and
performing, according to the target identifiers and the data set, at least one of the following:
training an artificial intelligence (AI) unit, wherein at least one of the AI unit and the data set is associated with the target identifiers;
performing inference on the AI unit; or
monitoring the AI unit.

20. A communication device, comprising a processor and a memory, wherein the memory stores a program or an instruction executable in the processor, and the program or the instruction, when executed by the processor, implements the steps of the data collection method according to claim 13.
